(19) United States
(12) Patent Application Publication
(10) Pub. No.: US 2003/0228545 A1
(43) Pub. Date: Dec. 11, 2003

(54) One-part bleach-fixing concentrate for silver halide color photographic light sensitive material and photographic processing method thereof

(76) Inventor: Tomoya Oda, Tokyo (JP)

Correspondence Address: MUSERLIAN AND LUCAS AND MERCANTI, LLP, 600 THIRD AVENUE, NEW YORK, NY, 10016, US

(21) Appl. No.: 10/431,836

(22) Filed: May 8, 2003

(30) Foreign Application Priority Data
May 17, 2002 (JP) JP2002-142851

(51) Int. Cl. G03C 5/44

(52) U.S. Cl. 430/461; 430/393

(57) ABSTRACT

A one-part photographic bleach-fixing concentrate including an iron (III) complex salt of an aminopolycaroxylic acid in an amount of 0.3 to 0.6 mol/l and a fixing agent, a ratio of ammonium ions to the total cationic ions being 0 to 50 mol %.

### TECHNICAL FIELD

The present invention relates to a bleach-fixing composition for silver halide color photographic light sensitive materials (hereinafter, shortened to photographic sensitized materials or photographic materials) and a photographic processing method using thereof. In further detail, the present invention relates to a one-part bleach-fixing concentration for silver halide color photographic light sensitive materials superior in simpler handling, stain resistance of finished photographic materials and reduced odor, and a photographic processing method thereof.

### BACKGROUND

Generally, photographic materials, after image exposure, form dye images by a series of photographic processes of a basic process comprised of a color development process and a desilvering process.

In the color development processes, reduced silver is generated during formation of photographic dye images by a coupling reaction of an oxidized color developing agent with coexisting color couplers. The generated silver is oxidized by a bleaching agent and changed to a soluble silver complex by a fixing agent in the subsequent desilvering process, which is then removed by a stabilizing process or a water washing process.

Generally, a desilvering process refers to a removal process of silver compounds existing in photographic sensitized materials, and this process is classified roughly into two steps. One is a bleaching process to oxidize silver contained in photographic sensitized materials to silver ions by an oxidizing agent, and the other is a fixing process to dissolve and remove silver ions formed by oxidation from photographic sensitized materials. These two steps may be conducted in two separate processes: the first using a bleaching solution followed by a fixing solution. These two steps may be conducted in one solution, being a bleaching and a fixing solution. One solution is introduced from the viewpoint of more rapid finishing. In general the latter is specifically called a bleach-fixing process.

Recently, in automatic processors, no water wash processing technology is introduced with the aim of lowered-pollution, and now almost all so-called mini-labs, using downsized automatic processors (hereinafter, referred to as mini-lab machines) employ the no water wash processing type automatic processors.

The degree of freedom of installation locations and unskilled operators has resulted in an increase and widespread use of no water wash processing type mini-lab machines, however, the unpleasant odor of chemicals, specifically ammonium, is a newly highlighted factor of the working environment and a focus for reduction of pollution load, and thus it is desired to develop improved processing technology to reduce the pollution load of water treatment plants.

As a main fixing agent used in a bleach-fixing solution or a fixing solution, thiosulfate has been used for many years. Recently, finishing in shops with a mini-lab machine has become the main stream in the photographic industry, and rapid access and reduction of the solution replenishment rate has been demanded, for which ammonium salts such as ammonium thiosulfate which are superior in fixing ability are used. Ammonium salts are superior from the desilvering point of view, however, the following problems are evident.

In general photographic processing processes including mini-lab machines, pre-determined volumes of replenishing solutions are added to processing baths for a specific finished photos volume or period of time of operation to maintain adequate reactivity of processing solutions. In a mini-lab machine, it is common that the replenishing solution, which is stored in a replenishing solution tank, is added to the processing bath via a supply means such as a pump.

The replenishing solution in the replenishing solution tank decreases with the progress of replenishment to the processing bath, and new replenishing solution is prepared using a replenishing solution preparation kit (a replenisher kit) which is then poured into the replenishing solution tank.

Such replenisher kits use concentrated solution to achieve a small size, and in many cases the kit is divided into several sub-kits for storage stability. Thus, each part of the sub-kits is poured into the replenishing solution tank, and a given volume of dilution water is added to obtain a given volume of replenishing solution. The operations of opening a sub-kit, pouring it into the tank and diluting it by adding water are conducted along with or by stopping printing operation, resulting in somewhat problematic tasks.

To reduce complication of plural sub-kits, a study of a bleach-fixing solution (BF) kit has been made. However, a bleach-fixing solution contains a basic bleaching agent and a basic fixing solution, and a basic fixing agent generally serves a reducing function, and therefore it is well known that both basic agents easily react with each other, resulting in deactivation, unless a preserving agent is included. Added as a preserving agent for this purpose, sulfite, for example, is used, but most preserving agents decompose over time. Still further, even if a preserving agent exists, both basic agents react excessively in cases of highly concentrated solutions, resulting in impairment of the primary function.

For this reason, one-part kits are known but the concentration of such is that non-diluted use or a certain restricted range of dilution, being much easier to use than multi-part kits. However, the replenishing solution kit itself occupies much space and is unsatisfactory from the handling point of view.

Regarding one-part concentrate of a bleach-fixing solution kit, the technologies of JP-A 2002-14449 (USP 2002/0010963 A1) (hereinafter, the term JP-A means Japanese Patent Application Publication) and JP-A 2000-98558 are disclosed, and attempts have been made to improve stability in kits. Based on the above technologies, decomposition of thiosulfate is effectively restrained, however, it has been proven that stability problems in kits include staining of edge areas of photographic materials (hereinafter, also referred to as edge penetration), in addition to problems of maintaining of desilvering capability. That is, even if a one-part kit has no problem of desilvering capability, it tends to have other problems of staining the edges of photographic materials.

As a result of the study about bleach-fixing solution contents and restraint of the edge penetration, it has been proven that deterioration tendency due to edge staining is differs based on the ammonium salt ratio contained in the kits. Specifically, the edge staining is much more worse with the stored kits. This edge staining is evident when a penetration prevention agent (a sizing agent) used in a paper base supporting the sensitized layers, decomposes due to deterioration of the developed sensitized materials over time. It is assumed that the ammonium salts superior in desilvering function exhibit superiority in penetration to other cations based on a logical analysis.

The problems to be solved in the present invention are to provide an effective one-part bleach-fixing solution for photographic sensitized materials, which addresses the unpleasant odor matter, is a concentrated one-part kit form and sufficiently restrains edge penetration during processing after storage in commercial product form and a photographic processing method thereof, considering the foregoing issues.

### SUMMARY

The present invention to solve the above described problems can be achieved by the following compositions.

1. A one-part photographic bleach-fixing concentrate for silver halide photographic light sensitive materials comprising an iron (III) complex salt of an aminopolycarboxylic acid in amount of 0.3 to 0.6 mol/L, and a fixing agent, wherein a ratio of ammonium ions to the total cationic ions is 0 to 50 mol %.

2. The one-part photographic bleach-fixing concentrate for silver halide photographic light sensitive materials described in 1. above, wherein the aminopolycarboxylic acid is selected from the group of compounds represented by Formulas (1), (1B) or (1C):

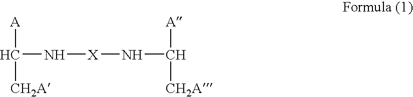

wherein A, A′, A″ and A′″ each represent —CH₂OH, —PO₃ PO₂, or —COOM, and each of which may be the same or different; M represents a hydrogen atom, an ammonium group, an alkali metal atom or an organic ammonium group;

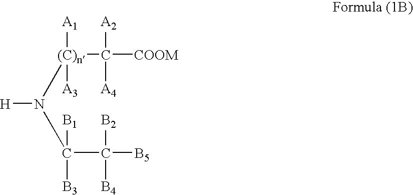

wherein n′ is an integer of 1 to 3; A₁ to A₄ and B₁ to B₅ each represent H, OH, CₙH₂ₙ₊₁ or (CH₂)ₘX; n and m represent integers of 1 to 3 and 0 to 3, respectively; X represents —COOM (wherein M is H, a cation or an alkali metallic atom), —NH₂ or —OH; provided that all of B₁ to B₅ can not be H at the same time.

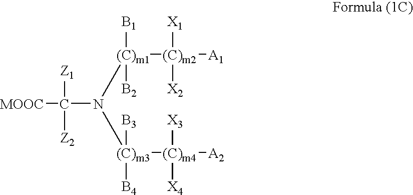

wherein B₁ to B₄ and X₁ to X₄ each represent H, CₙH₂ₙ₊₁ or (CH₂)ₗY; n and l are integers of 1 to 3 and 0 to 3, respectively, wherein Y is —COOM (M is H, a cation or an alkali metallic atom), —NH₂ or —OH; provided that all of B₁ to B₄ and X₁ and X₂ do not represent H at the same time, and any number, except 2, of X₁ to X₄ may represent OH at the same time; m₁ to m₄ each represent an integer of 0 to 3; A₁ and A₂ each represent —COOM₁, —COOM₂ (M₁ and M₂ each represent H, a cation or an alkali metallic atom), —NH₂ or OH; and Z₁ and Z₂ each represent —COOM (M is H, a cation or an alkali metallic atom), an alkyl group having 1 to 3 carbon atoms, or OH.

X represents an alkylene group having 2 to 6 carbon atoms or —(YO)n-Y′—; “n” is an integer of 1 to 6; Y and Y′, which may be the same or different, are each an alkylene group having 1 to 5 carbon atoms.

3. The one-part photographic bleach-fixing concentrate for silver halide color photographic light sensitive materials described in 1. or 2. above, wherein a compound represented by following Formula (2) is further contained:

A-(COOM)n Formula (2)

wherein “n” is 2 or 3; and when n=2, A is a single bond or divalent organic group, and when n=3, A is a trivalent organic group; M represents a hydrogen atom, an alkali metal or an ammonium group; M of n quantity may be the same or different.

4. The one-part photographic bleach-fixing concentrate for silver halide color photographic light sensitive materials described in 1., 2. or 3. above, wherein a compound represented by following Formulas (I) to (V) is further contained:

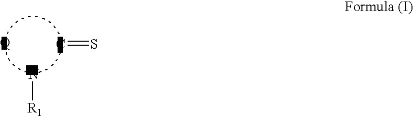

wherein Q represents a group of atoms which is necessary to form a heterocycle containing a nitrogen atom (containing a condensed 5 to 6-membered unsaturated ring); R₁ represents a hydrogen atom, an alkyl group having 1 to 6 carbon atoms, a cycloalkyl group, a heterocyclic group (containing a condensed 5 to 6-membered unsaturated ring), or an amino group.

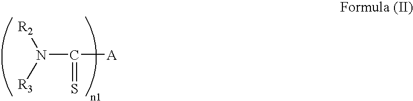

In Formula (II), R₂ and R₃ each represent a hydrogen atom, an alkyl group having 1 to 6 carbon atoms, a hydroxyl group, a carboxyl group, an amino group, an acyl group having 1 to 3 carbon atoms, an aryl group, or an alkenyl group; A represents —(C═X)—N(R), —(CH₂)n₂—(C═X)—N(R)(R′), —(S)m₁—(C═X)—N(R)(R′), —(S)m₂—(CH₂)n₃—(C═X)(R)(R′), —(S)m₃-(CH₂) n₄—N(R)(R′), —(S)m₄—N(R)(R′), —(NH) n₅— (CH₂)m₅—(NH)n₆—(C═X)—N(R)(R′), —S—S—(C═X)—N(R)(R′), —SZ, or n₁-valent heterocyclic residue (containing a condensed 5 to 6-membered unsaturated ring); R and R′ are each the same as R₂ and R3; X represents ═S, ═O, or ═NR″; Z represents a hydrogen atom, an alkali metal atom, an ammonium group, an amino group, a heterocyclic residue containing a nitrogen atom, an alkyl group, or —S—B—Y (R₄)(R₅); R″ represents a hydrogen atom, an alkyl group having 1 to 6 carbon atoms, a cycloalkyl group, an aryl group, a heterocyclic residue (containing a condensed 5 to 6-membered unsaturated ring), or an amino group; n₁ to n₆ and m₁ to m₅ each represent an integer of 1 to 6; B represents an alkylene group having 1 to 6 carbon atoms; Y represents —N<, ═C<, or CH<; R₄ and R₅ are the same as R₂ and R₃, but R₄ and R₅ may each represent —B—SZ; further R₂ and R₃, R and R′, R₄ and R₅ may each form a ring bonded to each other.

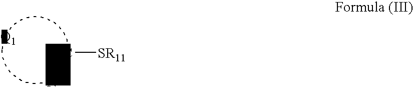

wherein Q₁ represents a group of atoms which is necessary to form a heterocycle containing a nitrogen atom (containing a condensed 5 to 6-membered unsaturated ring); R₁₁′ represents a hydrogen atom, an alkali metal atom,

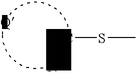

an alkyl group; Q′ is identical to Q₁.

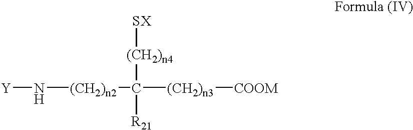

wherein n₂, n₃ and n₄ each represent an integer of 0 to 5; X represents a hydrogen atom, or an alkyl group having 1 to 5 carbon atoms; Y represents a hydrogen atom, a substituted or unsubstituted alkyl group, an acyl group; M represents a hydrogen atom, or an alkali metal atom; R₂₁ represents a substituted or unsubstituted alkyl group having 1 to 5 carbon atoms, or a hydrogen atom: and disulfide dimers of Formula (IV) are also contained.

Z₁—(CH₂)ₙ₅—S[(CH₂)ₙ₆—S]ₙ₇—(CH₂)ₙ₈—S—(CH₂)ₙ₉—Z₂ Formula (V)

wherein Z₁ and Z₂ represent a hydrogen atom, an alkyl group having 1 to 3 carbon atoms, an amino group, a carboxyl group, a sulfo group, or a hydroxyl group; n₅, n₆, n₇, n₈ and n₉ represent an integer of 0 to 5.

5. The one-part photographic bleach-fixing concentrate for silver halide color photographic light sensitive materials described in any of 1. through 4. above, wherein a ratio of ammonium-ions to the total cationic ions is 0 to 20 mol %.

6. A method for processing a silver halide color photographic light sensitive material comprising a step of:

introducing the one-part photographic bleach-fixing concentrate described in any of 1. through 5. above into a bleach-fixing bath of an automatic processor.

7. The method for processing a silver halide color photographic light sensitive material described in 6. above, wherein water is introduced in a bleach-fixing bath of an automatic processor.

### BRIEF DESCRIPTION OF THE DRAWINGS

FIG. 1 is a schematic diagram of an automatic processor referred to in Example 3.

FIG. 2 is a schematic diagram of the processing tanks portion used for the present invention.

### DESCRIPTION OF THE PREFERRED EMBODIMENTS

The present invention will be detailed below. Aminopolycarboxylic acid ferric (Fe(III)) complex salts used for this invention may be any of the several commonly known ones, and preferable are compounds represented by Formula (1), (1B) or (1C):

Compounds represented by foregoing Formulas (1), (1B) or (1C) can be synthesized by the commonly known methods described in Zh. Obshch. Khim., 49, 659 (1979), Inorganic Chemistry, Vol. 7, 2, 405 (1968); Chem. Zresti, 32, 37 (1978); U.S. Pat. No. 3,158,635 and JP-A 5-303186.

The compounds represented by Formulas (1), (1B) or (1C) in the present invention have optical isomers of [R, R], [R, L], [L, R] and [L, L]. These isomers can be synthesized individually or as mixtures. In this invention, [R, R] is preferable.

Preferable examples of the compounds presented by foregoing Formulas (1), (1B) or (1C) bin this invention are listed below, but the compounds which are usable in this invention and represented by Formulas (1) (1B) or (1C) are not limited to these examples.

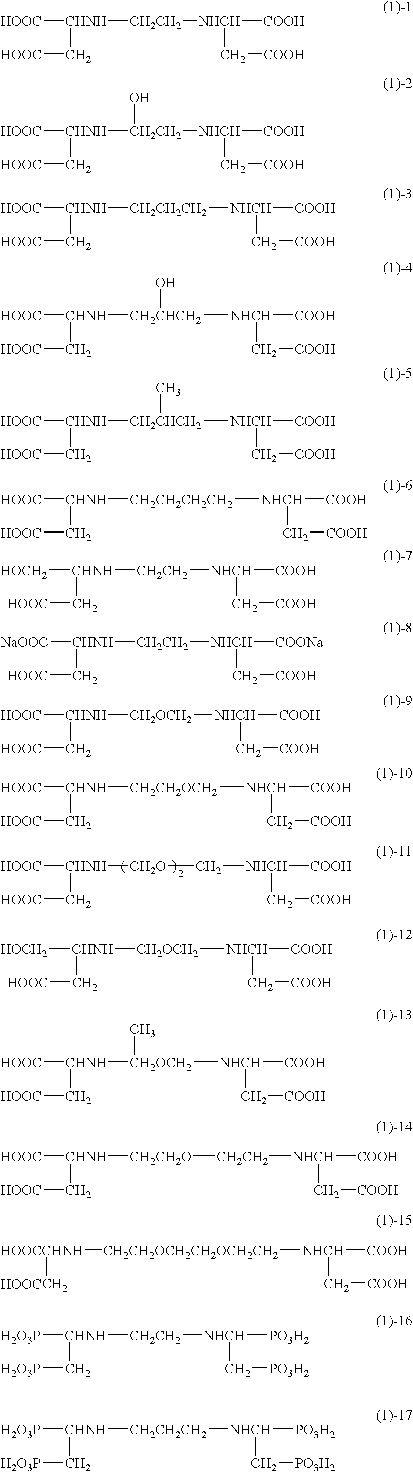

Among these compounds, preferred compounds are (1)-1, (1)-3 and (1)-4.

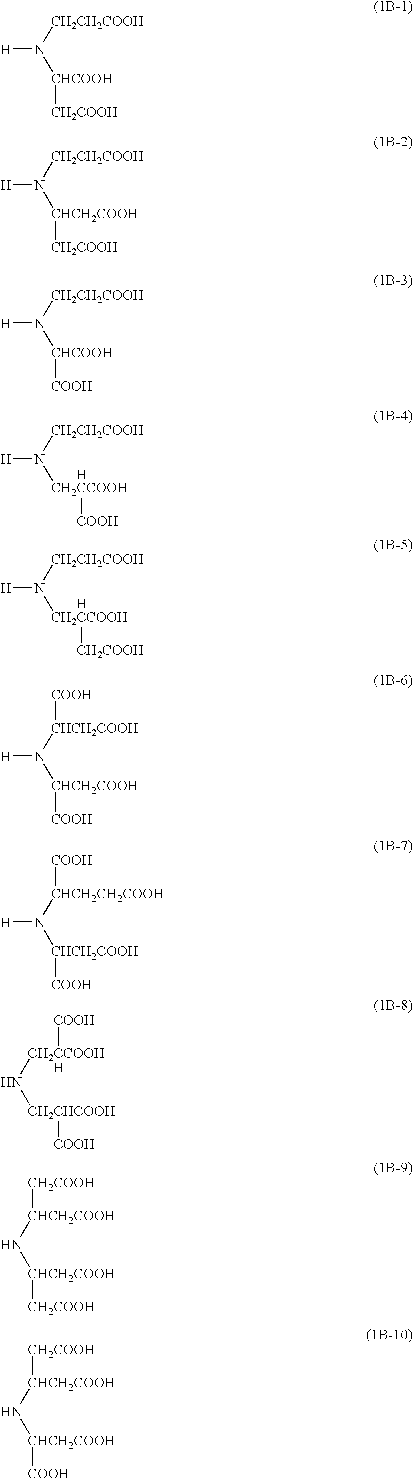

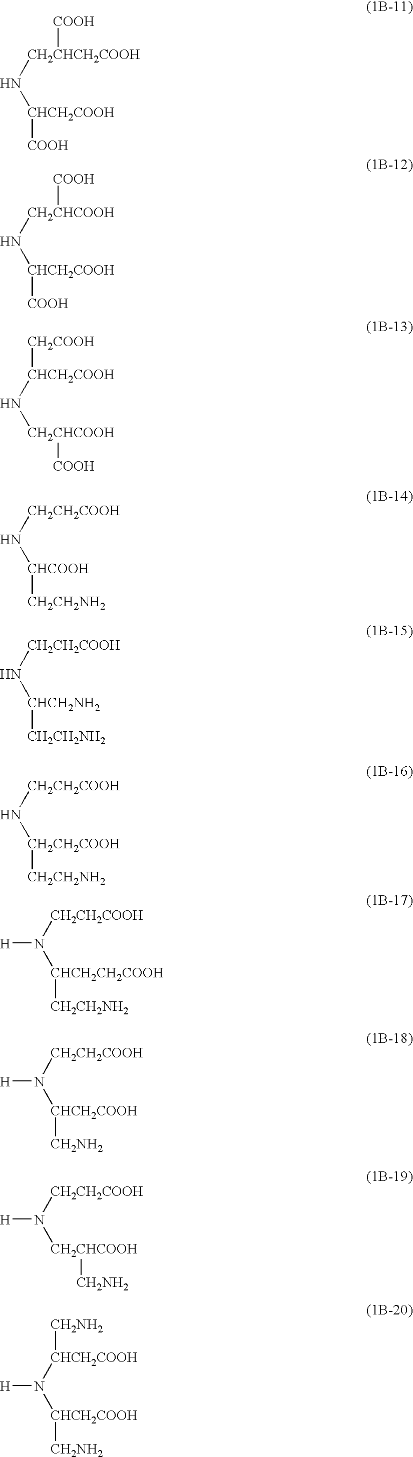

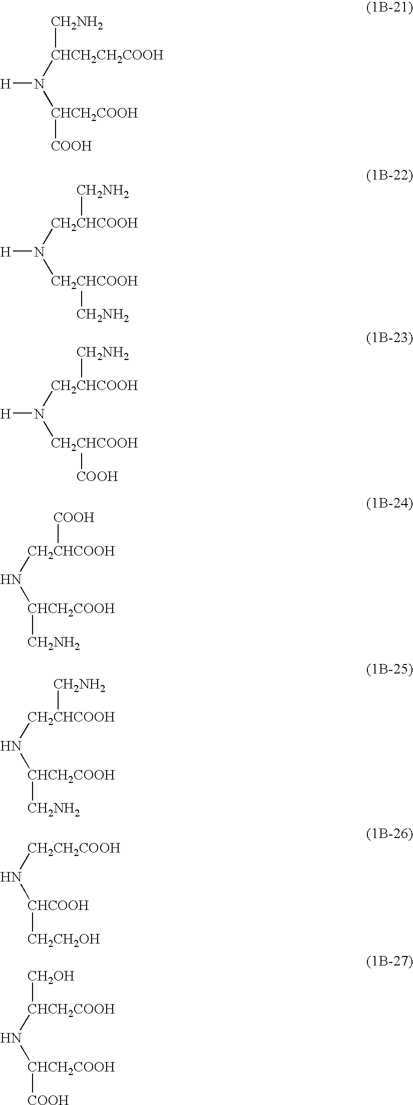

Among the above-exemplified compounds, the more preferred compounds are; 1B-1, 1B-3, 1B-6, 1B-8, 1B-14 and 1B-20.

The following are preferred examples represented by Formula (1C).

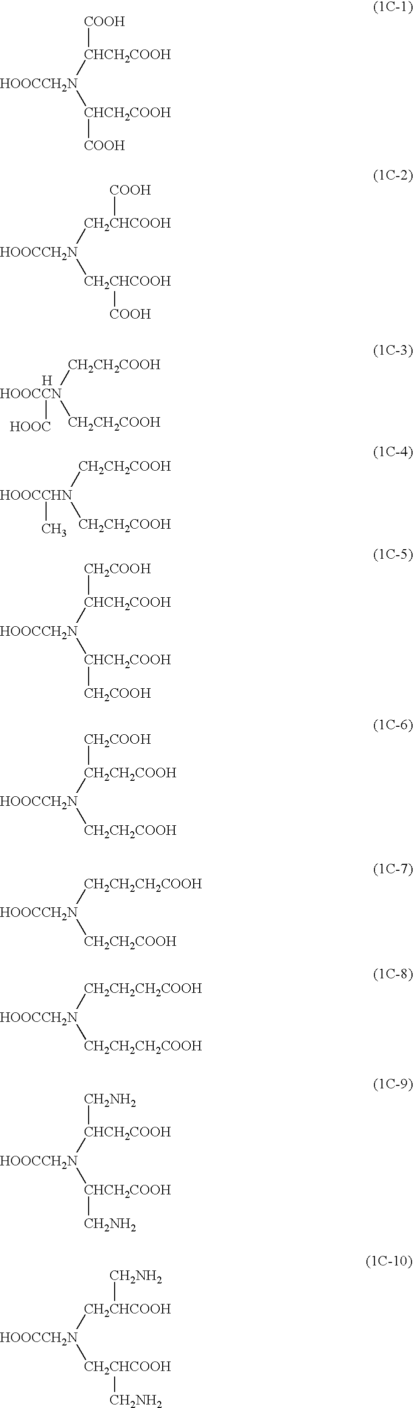

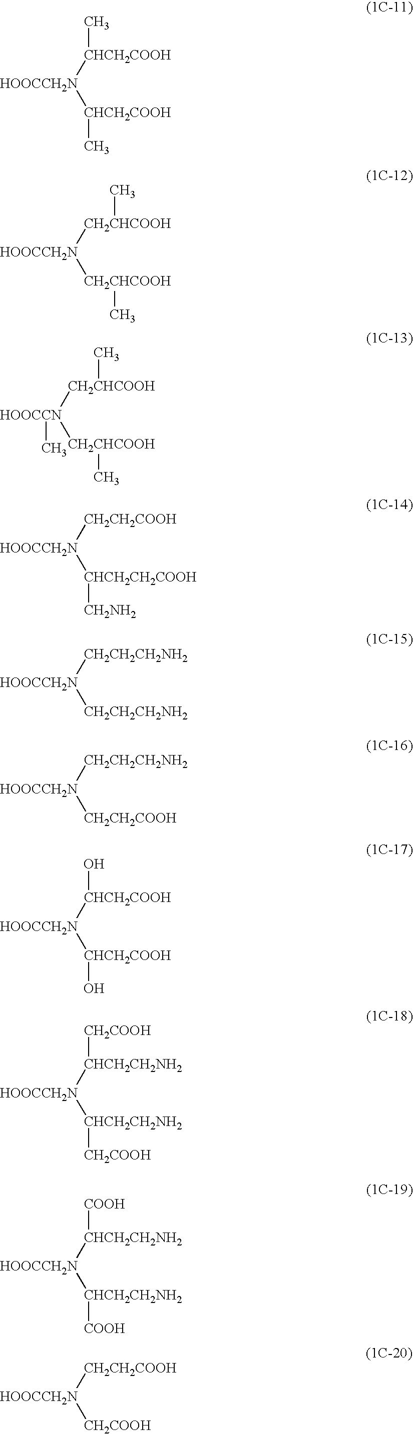

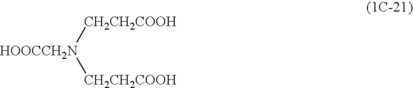

Among the above-exemplified compounds, the more preferred compounds are; 1C-1, 1C-2, 1C-3, 1C-4, 1C-11, 1C-12, 1C-17 and 1C-20.

One-part bleach-fixing compositions of this invention can be directly replenished into a processing tank and water for dilution can be separately replenished. Or, concentrated compositions and dilution water are mixed in a replenisher tank, and the resulting mixture is replenished as a diluted solution. Regarding to the ratio of replenishing concentrated compositions to dilution water at direct replenishment, or the dilution rate at the time of dilution replenishment, the total amount of the compounds represented by foregoing Formula (1) is preferably contained in the range of 0.05 to 2.0 mol/L per 1 liter, and more preferably 0.1 to 1.0 mol/L.

Further, the ratio of ammonium ion concentration based on the total amounts of cations is preferably not more than 50 mol % including 0, and more preferably not more than 20 mol % including 0.

The total amount of cations of the present invention is preferably 1.0 to 10.0 mol/l, and more preferably 1.5 to 6.0 mol/l

Another structure of the present invention contains the compounds represented by following Formula (2):

A—(COOM)ₙ Formula (2)

wherein “n” represents 2 or 3, and when n=2, A represents a single bond or divalent organic group, and when n=3, A represents a trivalent organic group; M represents a hydrogen atom, an alkali metal atom, or an ammonium group; M of n numbers may be the same or different.

Preferable examples of the compounds presented by foregoing Formula (2) in this invention are listed below, but the compounds which are usable in this invention and represented by Formula (2) are not limited to these examples. In the following listed examples, φ indicates that there is a substituent in a benzene ring, and m- and p-indicate that there is a substituent in a meta position and a para position respectively.

### EXAMPLES

(2)-1 HOOCCH₂C(OH)(COOH)CH₂COOH

(2)-2 HOOC—(CHOH)₂—COOH

(2)-3 HOOCCH₂COOH

(2)-4 HOOCCH(OH)CH₂COOH

(2)-5 HOOCCH═CHCOOH

(2)-6 HOOCCH₂CH₂COOH

(2)-7 (COOH)₂

(2)-8 m-HOOC-Φ-COOH

(2)-9 p-HOOC-Φ-COOH

(2)-10 NaOOCCH═CHCOONa

(2)-11 KOOCCH═CHCOOK

(2)-12H₄NOOCCH═CHCOONH₄

(2)-13 HOOC-(1,4-cyclohexyl)-COOH

(2)-14 m-NaOOC-Φ-COONa

(2)-15 p-NaOOC-Φ-COONa

(2)-16 HOOC(CH₂)₄COOH

(2)-17 HOOC(CH₂)₃COOH

(2)-18 HOOC—CH(PO₃H₂)—CH₂COOH

(2)-19 HOOCCH₂—C(COOH)(PO₃H₂)—CH₂COOH

(2)-20 HOOCCH₂—C(COOH)(PO₃H₂)—CH₂CH₂COOH

Of these, preferably used for the processing solution of this invention are (2)-1, (2)-3, (2)-4, (2)-5, (2)-6, (2)-16, and (2)-17, and specifically preferably are (2)-5 and (2)-6.

The added amount of these compounds, as concentration used for bleach-fixing solution, is preferably 1.5 mol/L or less, more preferably is 0.05 to 1.0 mol/L. Further, these compounds may be used alone or in combination more than two kinds.

Another structure of the present invention contains at least one of compounds represented by foregoing Formulas [I] to [V].

Examples of the compounds which are used in this invention and represented by Formulas [I] to [V] are listed below.

### EXAMPLES

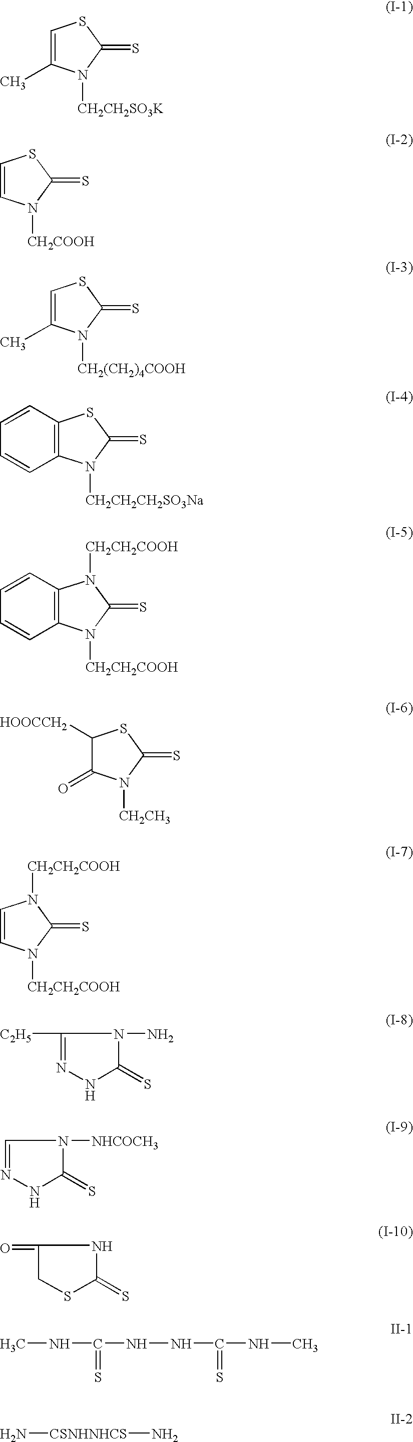

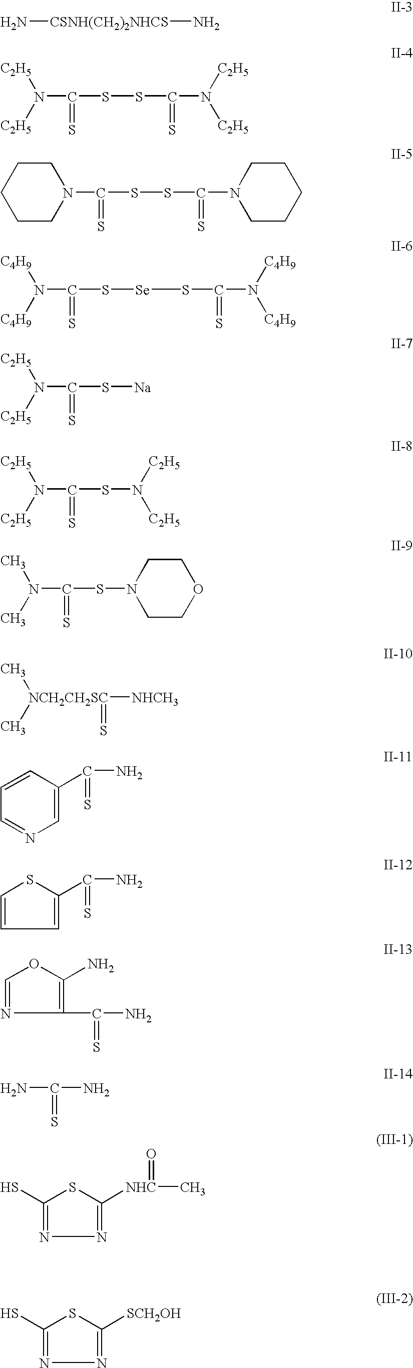

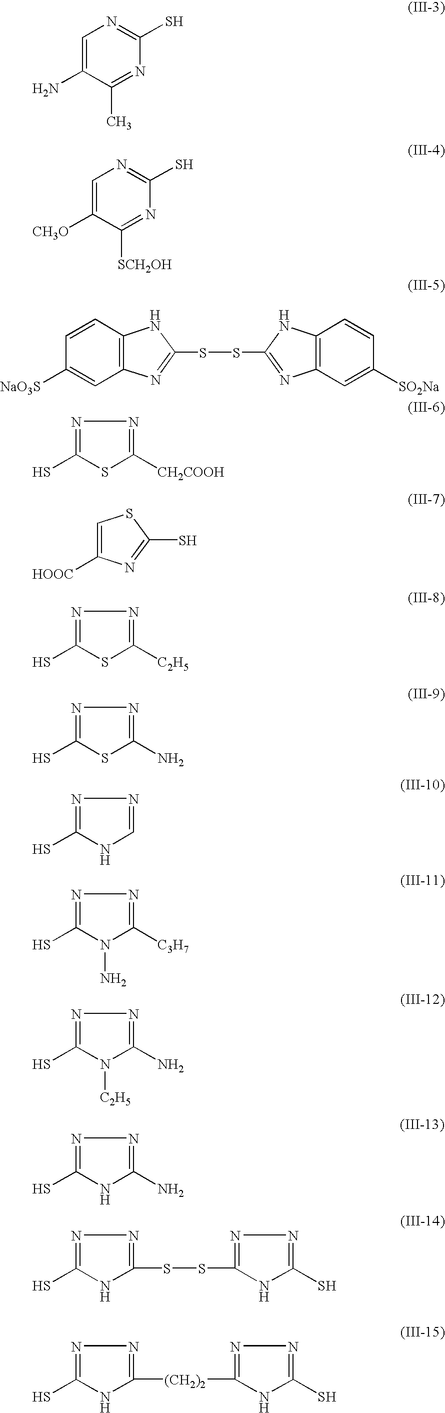

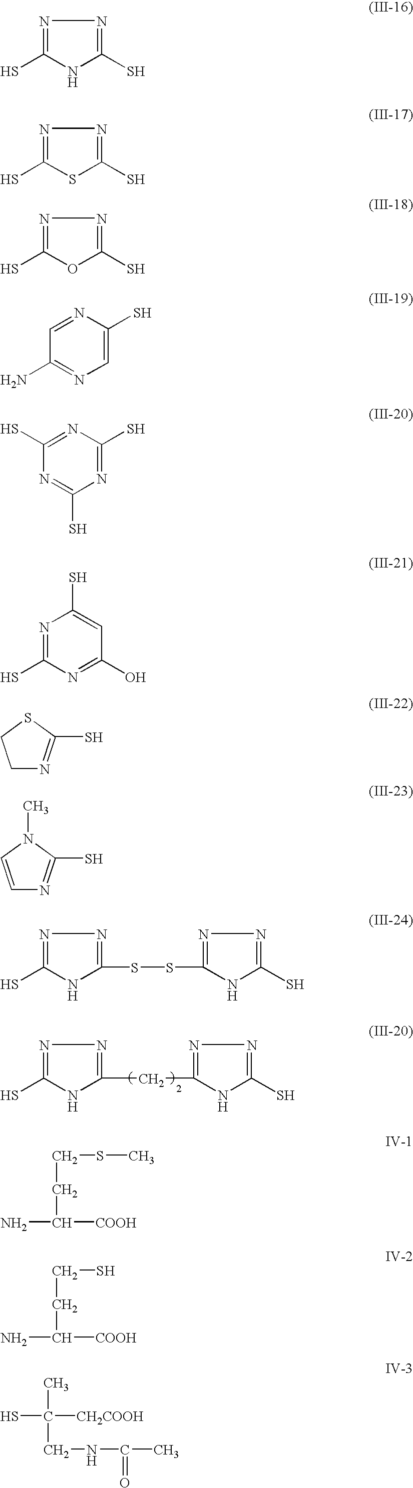

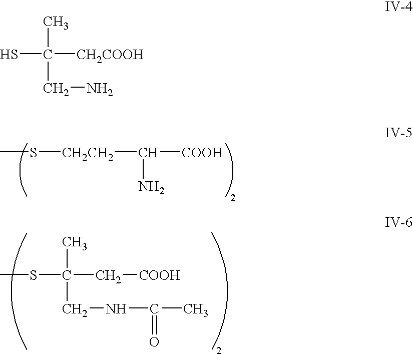

V-1 HO—CH₂CH₂—S—CH₂CH₂—S—CH₂CH₂—OH

V-2 HOOC—CH₂CH₂—S—CH₂CH₂—S—CH₂CH₂—COOH

V-3 CH₃CH₂—S—CH₂CH₂—S—CH₂CH₃

V-4 CH₃—CH₂CH₂—S—CH₂CH₂—S—CH₂CH₂—CH₃

V-5 NH₂—CH₂CH₂—S—CH₂CH₂—S—CH₂CH₂—SO₃H

V-6 HO—CH₂CH₂—S—CH₂CH₂—S—CH₂CH₂—S—CH₂CH₂—OH

V-7 HO—CH₂CH₂CH₂—S—CH₂CH₂—S—CH₂CH₂—OH

V-8 HO—CH₂CH₂—S—CH₂CH₂CH₂—S—CH₂CH₂—OH

Of the above compounds, preferably used compounds from the point of view of this invention are I-2, II-2, the compounds represented by Formula [III], IV-1, IV-3, IV-5, and the compounds represented by Formula [V].

Of the compounds represented by Formula [III], preferably used are III-9, III-10, III-13, III-22, and III-23. Of the compounds represented by Formula [V], preferably used are V-1 and V-2. Specifically preferably used are III-10, III-13, III-23 and V-1.

These compounds can be employed alone or in combination more than two kinds. Further, these compounds are preferably added to the one-part bleach-fixing compositions of this invention along with at least one other processing solution, in order to work more effectively. In cases where the compounds are added to more than two solutions, they may be different types of compounds.

In cases when the compounds represented by foregoing Formulas [I] to [V] are employed in the one-part bleach-fixing composition of this invention, the added amount of the compounds represented by above Formulas [I] to [V] is preferably designed, from the view point of the effect of the invention and precipitation, to be in the range of 0.0001 to 0.1 mol/L in the bleach-fixing processing tank, more preferably designed to be in the range of 0.001 to 0.05 mol/L, and still more preferably in the range of 0.005 to 0.03 mol/L.

When the one-part bleach-fixing composition of this invention is used in an automatic processor, the one-part bleach-fixing composition or its diluted replenishing solution is added to the bleach-fixing processing tank. The replenishing volume of the bleach-fixing replenishment solution, adding up the volume of replenishing water supplied separately from direct replenishment of the bleach-fixing replenishment solution, is preferably 500 ml or less per m² of the processed silver halide photosensitized materials, more preferably in the range of 20 to 400 ml, and still more preferably in the range of 40 to 350 ml.

The one-part bleach-fixing compositions of this invention may contain various preserving agents, fluorescent brightening agents, antifoaming agents, or surface active agents in addition to fixing agents.

As fixing agents of this invention, thiocyanates and thiosulfates are preferably used. When thiocyanates are used as fixing agents, the content of thiocyanates in the bleach-fixing processing tank is preferably at least 0.3 mol/L or more, and for processing of color negative film is preferably 0.5 mol/L or more, and specifically preferably 1.0 mol/L or more. When thiosulfates are used as fixing agents, the content of thiosulfates is at least 1.0 mol/L or more, and for processing of color negative film is preferably 1.5 mol/L.

Meanwhile, using commonly known methods, silver can be recovered from the bleach-fixing solution obtained from the one-part bleach-fixing compositions of this invention.

The processing time of the bleach-fixing solution obtained from the one-part bleach-fixing compositions of this invention can be determined on an individual cure basis, but is preferably 4 minutes or less, and more preferably in the range of 10 seconds to 2 min. 20 sec.

Silver halide photographic sensitized materials can be subjected to a stabilizing process by water washing or a stabilizing solution, after processing with the bleach-fixing solution obtained from the one-part bleach-fixing compositions of this invention.

It is preferred that a stabilizing solution contains chelating agents having the chelating stability constant of more than 8 for iron ions. Herein, the chelating stability constant refers to as the constant commonly known as described in “Stability Constants of Metal-ion Complexes”, L. G. Sillen and A. E. Martell, The Chemical Society, London (1964), and “Organic Sequestering Agents”, S. Chaberek and A. E. Martell, Wiley (1959).

Examples of chelating agents having the chelating stability constant of more than 8 for iron ions include organic carboxylic acid chelating agents, organic phosphoric acid chelating agents, and polyhydroxy compounds. The foregoing term of iron ion means ferric ion [Fe(III)].

Exemplary compounds of chelating agents having the chelating stability constant of more than 8 for iron ions include ethylenediaminediorthohydroxyphenylacetic acid, diaminopropanetetraacetic acid, nitrilotriacetic acid, hydroxyethylenediaminetriacetic acid, dihydroxyethylglysine, ethylenediaminediacetic acid, ethylenediaminedipropyonic acid, iminodiacetic acid, diethylenetriaminepentaacetic acid, hydroxyethyliminodiacetic acid, diaminopropanoltetraacetic acid, transcyclohexanediaminetetraacetic acid, glycoleterdiaminetetraacetic acid, ethylenediaminetetrakismethylenephosphonic acid, nitrilotrimethylenephosphonic acid, 1-hydroxyethylidene-1,1-diphosphonic acid, 1,1-diphosphonoethane-2-carboxylic acid, 2-phosphonobutane-1,2,4-tricarboxylic acid, 1-hydroxy-1-phosphonopropane-1,2,3-tricarboxylic acid, catechol-3,5-diphosphonic acid, sodium pyrophosphate, sodium tetrapolyphosphate, and sodium hexametaphosphate, but are not limited to these. Of these, diethylenetriaminepentaacetic acid, nitrilotriacetic acid, nitrilotrimethylenephosphonic acid, 1-hydroxyethylidene-1,1-diphosphonic acid are preferable, and specifically 1-hydroxyethylidene-1,1-diphosphonic acid is more preferable.

The used amount of the foregoing chelating agents is preferably 0.01 to 50 g per liter of a stabilizing solution, and more preferably in the range of 0.05 to 20 g/L.

Further, other additives may be added to the stabilizing solution. These compounds include ammonium compounds. Such ammonium compounds may be inorganic or organic ammonium salts, examples of which include ammonium hydroxide, ammonium bromide, ammonium carbonate, ammonium chloride, ammonium hypophosphite, ammonium phosphate, ammonium phosphite, ammonium fluoride, acid ammonium fluoride, ammonium fluoroborate, ammonium arsenate, ammonium hydrogencarbonate, ammonium hydrogenfluoride, ammonium hydrogensulfate, ammonium sulfate, ammonium iodide, ammonium nitrate, ammonium pentaborate, ammonium acetate, ammonium adipate, ammonium laurylintricarbonate, ammonium benzoate, ammonium carbamate, ammonium citrate, ammonium diethyldithiocabamate, ammonium formate, ammonium hydrogenmalate, ammonium binoxalate, ammonium hydrogenphthalate, ammonium bitartrate, ammonium thiosulfate, ammonium sulfite, ammonium ethylenediaminetetraacetate, ferric ammonium ethylenediaminetetraacetate, ammonium lactate, ammonium malate, ammonium maleate, ammonium oxalate, ammonium phthalate, ammonium picrate, ammonium pyrrolidinedithiocarbamate, ammonium salicylate, ammonium succinate, ammonium sulfanilate, ammonium tartrate, ammonium thioglycolate, and 2,4,6-trinitrophenol ammonium. These may be used alone or in combinations of more than two. The added amount of the ammonium compounds is preferably in the range of 0.001 to 1.0 mol per liter of the stabilizing solution, and more preferably in the range of 0.002 to 0.8 mol.

It is also preferable to provide sulfite salts in the stabilizing solution. Any organic or inorganic salts are usable, sulfite salts of which release sulfite ions, however, preferred are inorganic salts. Examples of preferable compounds include sodium sulfite, potassium sulfite, ammonium sulfite, ammonium bisulfite, potassium bisulfite, sodium bisulfite, sodium metabisulfite, potassium metabisulfite, ammonium metabisulfite, and hydrosulfite. The foregoing sulfites are preferably added in the amount of at least 1×10⁻³ mol/L in the stabilizing solution, and more preferably 5×10⁻³ to 10−1 mol/L. The addition of sulfite salts is specifically effective to prevent staining. The sulfite salts may be directly added to the stabilizing solution, but it is preferable for them to be added to the stabilizing solution replenisher.

In addition, other compounds which are generally added are usually added to the stabilizing solution. Examples of these compounds include polyvinyl pyrrolidone (PVP K-15, K-30, K-90), organic acid salts (e.g., salts of citric acid, acetic acid, succinic acid, oxalic acid, benzoic acid, and malic acid), pH adjusting agents (e.g., phosphates, borates, hydrochloric acid, or sulfuric acid), fungicides (e.g., phenol derivatives, catechol derivatives, imidazole derivatives, triazole derivatives, thiabendazole derivatives, organic halogenated compounds, and fungicides known as slime control agents in the paper-pulp industry), fluorescent brightening agents, surface active agents, antiseptic agents, as well as metallic salts of Bi, Mg, Zn, Ni, Al, Sn, Ti, and Zr. One or more than two of these compounds may be selected as appropriate.

Soluble iron salts may also be added to the stabilizing solution. Soluble iron salts are preferably added to the stabilizing solution of the concentration of at least 5×10⁻³ mol/L, more preferably in the range of 8×10⁻³ to 150×10⁻³ mol/L, and still more preferably in the range of 12×10⁻³ to 100×10⁻³ mol/L. These soluble iron salts may be added to the stabilizing solution (the tank solution) by addition into the stabilizing solution replenisher, or by dissolution from photographic sensitized materials, or further, by being carried in from the previous bath adhering to the processed photographic sensitized materials.

Further, each of calcium ions and magnesium ions in the stabilizing solution may be less than 5 ppm utilizing an ion-exchange resin process. Also, halogen ion releasing compounds may be incorporated in the stabilizing solution.

The pH of the stabilizing solution is preferably adjusted to the range of 5.5 to 10.0 by adding pH adjusting agents. Any commonly known alkaline chemicals or acidic chemicals may be used as pH adjusting agents.

The processing temperature of the stabilizing process is preferably 15° to 70° C., and more preferably 20° to 55° C. Further, the processing time is preferably less than 120 seconds, more preferably 3 to 90 seconds, and still more preferably 6 to 50 seconds.

When the stabilizing process is conducted by a replenisher method with the stabilizing solution replenishing solution, the replenishing volume of the stabilizing solution replenishing solution is preferably 0.1 to 50 times of the carry-in volume of the previous bath (the bleach-fixing solution) per an unit area of photographic sensitized materials, from the view point of quick processing and storage stability of dye images, and specifically preferably 0.5 to 30 times.

Stabilizing tanks for stabilizing process preferably comprise plural tanks of more than 2 and less than 6 tanks, specifically preferably 2 to 3 tanks, and still more preferably 3 tanks with a countercurrent method (a method to supply a replenishing solution to the post-bath and to overflow from the pre-bath).

A water wash process in not necessary when stabilizing processing is conducted, however, rinse or surface wash with a small amount of water for quite a short time can be conducted as appropriate.

Silver halide color photographic light sensitive materials are subjected to color development processing prior to processing using the bleach-fixing solution of this invention.

A color development process may be conducted in so-called tank development where the processed silver halide photographic sensitized materials are introduced into tanks filled with processing solutions, however, conducted by a method to supply a necessary volume of the development process by means of a spray or coating described in JP-A Nos. 2000-89438 and 2001-166448, in order to prevent deterioration of the processing solution and to down-size the processing apparatuses. Color development replenisher can be supplied by divided it into more than two solutions when the color development solution is supplied to silver halide photographic sensitized materials as a spray or coating, and thus, this method is preferred from storage stability of the replenisher point of view.

Color developing agents used in color development processing include aminophenol type compounds and p-phenylenediamine type compounds. It is preferable to use p-phenylenediamine type compounds having a water soluble group as a color developing agent. There is at least one water soluble group in an amino group or a benzene ring of these p-phenylenediamine compounds. Examples of preferable water soluble groups include —(CH₂)ₙ—CH₂OH, —(CH₂)m-NHSO₂—(CH₂)n-CH₃, —(CH₂)m-O—(CH₂)n-CH₃, —(CH₂CH₂O)n-CmH₂ m+₁ (“m” and “n” each represent a integer of 0 or more), a —COOH group, and a —SO3H group.

Exemplary compounds are listed below.

### EXAMPLES OF COLOR DEVELOPING AGENTS

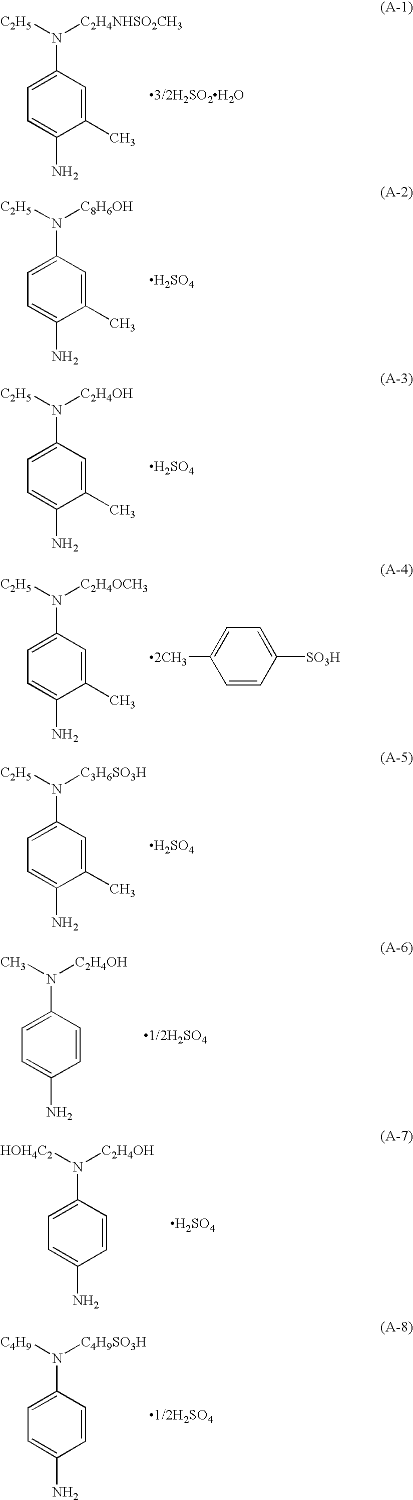

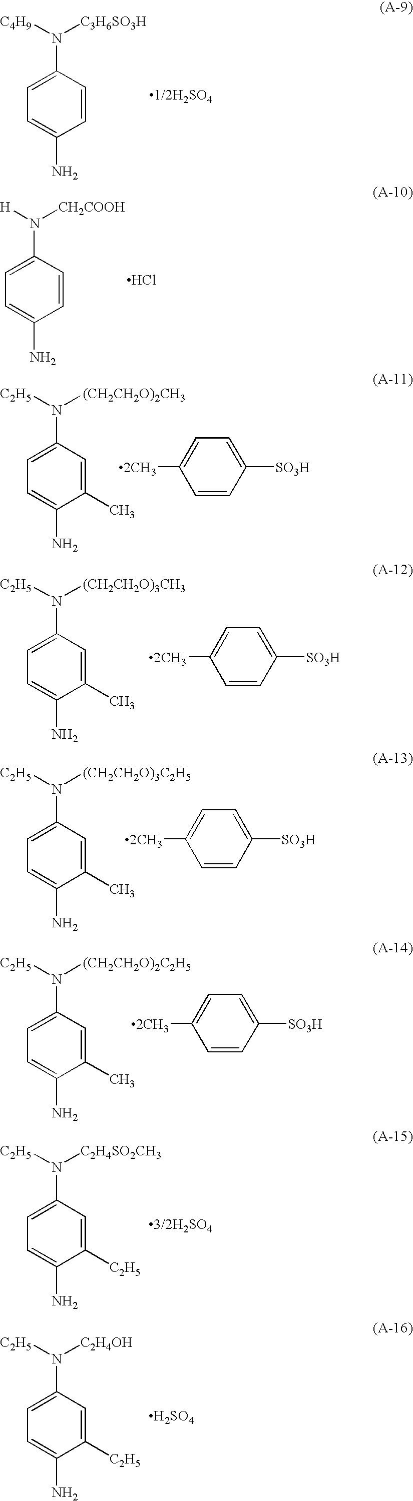

Of these color developing agents exemplified above, preferable compounds are (A-1), (A-2), (A-3), (A-4), (A-6), (A-7) and (A-15), and specifically (A-1) and (A-3).

The above-mentioned color developing agents are usually employed in the form of salts such as chlorides, sulfates, p-toluenesulfonates, etc.

The added amount of a color developing agent to a color developing solution is preferably 0.5×10⁻² or more mol per liter of the color developing solution, more preferably in the range of 1.0×10⁻² to 1.0×10⁻¹ mol, and still more preferably in the range of 1.5×10⁻² to 7.0×10⁻² mol.

A color developing solution may contain commonly used alkaline chemicals in a developing solution such as sodium hydroxide, potassium hydroxide, ammonium hydroxide, sodium carbonate, potassium carbonate, sodium sulfate, sodium metaborate, or borax. Further, The color developing solution may contain various additives such as benzyl alcohol; alkali halides; potassium bromide or potassium chloride; development adjusting agents such as citrazinic acid; and preserving agents such as hydroxylamine, hydroxylamine derivatives (e.g., diethylhydroxylamine, disulfoethylhydroxylamine, dicarboxyethylhydroxylamine), hydrazine derivatives (e.g., hydrazinodiacetic acid), and sulfites. In addition, the color developing solution may optionally contain various antifoaming agents, surface activation agents, and organic solvents such as methanol, dimethylformamide or dimethylsulfoxide.

pH of the color developing solution for the tank development is generally 7 or more, and preferably about 9 to 13.

In cases when the color developing solution is supplied via a method in which the solution is divided into more than two solutions and supplied by a spray or coating, ph of the color developing agent containing part is usually 7 or less, and preferably in the range of about 1 to 5. A solution containing a color developing agent exhibits extremely low color forming ability in acidic conditions. Therefore, when all parts of the developing solution are provided on silver halide photographic sensitized materials, pH of the mixed solution is preferably 7 or more, and more preferably in the range of 9 to 13.

In the color developing solution, oxidation inhibitors, when appropriate, may be contained tetronic acid, tetronimide, 2-anilinoethanol, dihydroxyacetone, aromatic secondary alcohols, hydroxamic acid, pentose or hexose, or pyrogallol-1,3-dimethyl ether.

In the color developing solution, various chelating agents may contain a combination of sequestering agents. Examples of these chelating agents include aminopolycarboxylic acid such as ethylenediaminetetraacetic acid, diethylenetriaminepentaacetic acid; organic phosphonic acid, such as 1-hydroxyethylidene-1,1-diphosphonic acid; aminophosphonic acid such as aminotrimethylenephosphonic acid and ethylenediaminetetraphosphonic acid; oxycarboxylic acid such as citric acid and gluconic acid; phosphonocarboxylic acid such as 2-phosphonobutane-1, 2, 4-tricarboxylic acid; polyphosphoric acid such as tripolyphosphoric acid and hexametaphosphoric acid.

Silver halide photographic sensitized materials which are processed with the processing solution obtained from the one-part bleach-fixing compositions of the present invention are preferably comprised of at least one layer of the silver halide emulsion layers containing silver chloride grains comprised of silver chloride of more than 90%, preferably 95 to 99.9%, and more preferably 98 to 99.9%. Further, all layers of the silver halide photographic sensitized materials are preferably comprised of silver chlorobromide emulsion layers containing 98 to 99.9% silver chloride.

The raw material used for such paper support of the foregoing silver halide photographic sensitized materials is made of wood pulp as the principal raw material; and synthesized pulp of polypropylene and synthesized fibers of nylon or polyester may be added to the wood pulp based on necessity. As wood pulp, LBKP, LBSP, NBKP, NBSP, LDP, NDP, LUKP and NUKP may also be used. It is preferable that LBKP, NBSP, LBSP, NDP and LDP, each containing many short fibers are used in a larger amount. The content of LBSP or LDP is preferably from 10% to 70% by weight.

As the foregoing pulp, chemical pulp (sulfate pulp and sulfite pulp) with a small amount of impurities is preferably employed. Bleached pulp enhanced in whiteness is also advantageously used.

Into the raw paper, an additive, for example, a sizing agent such as a higher fatty acid or an alkylketene dimer; a white pigment such as calcium carbonate, talc, or titanium oxide; a paper strength increasing agent such as starch, polyacrylamide or polyvinyl alcohol; a fluorescent brightening agent; a moisture holding agent such as polyethylene glycol; a dispersion agent; and a softening agent such as a quaternary ammonium may suitably be added.

The beating degree of the pulp to be used for paper making is preferably from 200 to 500 ml according to the definition of CSF. As to the fiber length of the pulp after beating, it is preferable that the sum of 24 mesh remaining ingredients and 42 mesh remaining ingredients defined by JIS-P-8207 is from 30 to 70% by weight. The 4 mesh remaining ingredients are preferably not more than 20% by weight.

The thickness of the raw paper is preferably from 140 to 350 μm, and more preferably 160 to 250 μm.

The raw paper may be given high smoothness by a calendering treatment in the course of or after the paper making. The density of the raw paper according to JIS-P-8118 is usually from 0.7 to 1.2 g/m^{2,} while the stiffness of the raw paper is preferably from 20 to 200 g according to the condition defined by JIS-P-8143.

A surface sizing agent may be coated onto the surface of the raw paper. As the surface sizing agent, the same sizing agent as to be added to the foregoing raw paper can be used.

The pH of the raw paper is preferably from 5 to 9 when the pH is measured by the hot water extraction method defined in JIS-P-8113.

Although the polyethylene covering both surfaces of the raw paper is composed mainly of low density polyethylene (LDPE) and/or high density polyethylene (HDPE), alternatively LLDPE or polypropylene may also be used at a partial level.

Specifically, the polyethylene layer on the porous layer side is preferably one containing rutile or anatase type titanium oxide to improve opacity and whiteness of the polyethylene layer such as is widely used for photographic paper. The content of titanium oxide is usually from 3 to 20%, preferably from 4 to 13%, by weight of polyethylene.

Polyethylene laminated paper may be used in this invention, not only for glossy paper but also for the matte or silk surface usually used in photographic paper, which is formed by an embossing treatment during extrusion of polyethylene onto the raw paper.

The utilized amount of polyethylene providing on the front or rear surface of the raw paper is selected so that the paper exhibits suitable curling after provision of the porous layer and the backing layer. The thickness of the polyethylene layer on the porous layer side is usually from 20 to 40 μm, and that of the polyethylene layer on the backing layer side is usually from 10 to 30 μm.

The silver halide crystals used for the foregoing silver halide photographic sensitized materials may be regular crystals, twin crystals or other types, and the ratio of (1. 0. 0) face and (1. 1. 1) face may be selected for optimal results. Further, the crystal structure of these silver halide grains may be uniform from their interior to their exterior, or non-homogeneous layer structure in the interior and on the exterior (core-shell type). Also, the silver halide may be a type which forms latent images on the surface of the grain, or in the interior of the grain. Furthermore, tabular silver halide grains may be employed (JP-A Nos. 58-113934 and 59-170070).

Additionally, the foregoing silver halide grains may be prepared by acidic precipitation, neutral precipitation or ammoniacal precipitation.

Also, the silver halide grains, after formation of seed grains by acidic precipitation, may be grown to the given size by ammoniacal precipitation which exhibits a rapid growth rate. It is preferable that pH and pAg in the reaction tank is controlled during the growth of the silver halide grains while silver ions and halide ions, at volumes appropriate to the growth rate of the silver halide grains, are injected and mixed sequentially or at the same time as described in JP-A 54-48521.

Preparation of the foregoing silver halide grains is preferably conducted as described above. The composition containing the silver halide grains refers to silver halide emulsion in this invention.

The silver halide emulsion layers containing the silver halide grains used in this invention contain color couplers. These color couplers react with oxidation products of the color developing agents to form nondiffusing dyes. These color couplers are advantageously incorporated in the light sensitive layers in a nondiffusing form or in the adjacent layers.

Thus, a red light-sensitive layer may contain nondiffusing couplers to form cyan color images, which are generally phenol or α-naphthol type color couplers. A green light-sensitive layer may contain at least one nondiffusing color coupler to form magenta color images, which is generally a 5-pyrazolone type color coupler or a pyrazolotriazole type color coupler. A blue light-sensitive layer may contain at least one nondiffusing color coupler to form yellow color images, which is generally a color coupler having an open-chained ketomethylene group. The color couplers may be six-equivalent, four-equivalent or two-equivalent couplers. In this invention, two-equivalent couplers are specifically preferable.

Suitable couplers are listed in the following publications: W. Perz, “Farbkuppler” in Mitteilungen aus den Forschungslaboratorien der Agfa, Leverkusen/Munchen, vol. III, p.111 (1961); K. Venkataraman, “The Chemistry of Synthetic Dyes”, vol. 4, pg. 341 through 387, Academic Press; “The Theory of the Photographic Process”, 4^{th} ed., pg. 353 through 362; and Research Disclosure No. 17643, Sec. VII.

In this invention, such couplers are preferred to be used in combination with the photographic sensitized materials of this invention, from the most effective point of view of this invention, as magenta couplers represented by Formula (M-1) described in JP-A 63-106655, pg. 26 (exemplified magenta couplers are Nos. 1 through 77 described in JP-A 63-106655, in pg. 29 through 34); cyan couplers represented by Formulas (C-I) or (C-II) described in pg. 34 of the same JP-A [exemplified cyan couplers are (C′-1) through (C′-82) and (C″-1) through (C″-36) described on pg. 37 through 42 of the same JP-A]; high speed yellow couplers described on pg. 20 of the same JP-A [exemplified yellow couplers are (Y′-1) through (Y′-39) described in pg. 21 through 26 of the same JP-A].

In this invention, the use of heterocyclic mercapto compounds containing nitrogen atom combined with the high silver chloride photographic sensitized materials is pointed as a very preferable embodiment, not only for its preferable effect of the invention, but also the additional effect to lessen extreme affects of photographic performance when the bleach-fixing solution is mixed in the color developing solution.

Examples of the heterocyclic mercapto compounds containing a nitrogen atom include (I′-1) through (I′-87) described in JP-A 63-106655, pg. 42 through 45.

This emulsion can be chemically sensitized. For this purpose, compounds containing sulfur such as arylisothiocyanate, arylthiourea or thiosulfate, are specifically preferred.

Reducing agents may also be employed as chemical sensitizing agents. These are silver compounds described in Belgian Patents 493,464 and 568,687, as well as polyamine such as diethylenetriamine or aminomethylsulfinic acid derivatives described in Belgian Patent 574,323. Noble metals such as gold, platinum, palladium, iridium, ruthenium and rhodium, and noble metal compounds are also acceptable sensitizing agents. This chemical sensitizing method is described in R. Koslovsky, Z. Wiss. Photo., 46, pg. 65 through 72 (1951); and also the foregoing Research Disclosure No. 17643, Sect. II and III.

The emulsion may be spectrally sensitized using commonly known methods. The spectral sensitization may be conducted by employing, for example, cyanine, merocyanine, complex cyanine, complex merocyanine, holopolarcyanine, or hemicyanine, used alone or in combinations thereof. Please refer F. M. Hamer, “The Cyanine Dyes and Related Compounds”, 1964; Ullmanns Enzyklpadieder Technischen Chemie, 4^{th} ed., vol. 18, pp. 431 and 432; and the above Research Disclosure No. 17643, sec. IV.

Common anti-fogging agents and stabilizing agents may be added to the emulsion. Azaindenes are specifically acceptable stabilizing agents. Tetra- and penta-azaindens are preferable, while specifically preferable are those substituted by a hydroxyl group or an amino group. These compounds are described in Birr, Z. Wiss. Photo., 47, pg. 02 through 58, 1952, and the foregoing Research Disclosure No. 17643, sec. IV. Constituents of the photographic sensitized materials may be provided by using commonly known methods which are described in, for example, U.S. Pat. Nos. 2,322,027, 2,533,514, 3,689,271, 3,764,336 and 3,765,897.

Constituents of the photographic sensitized materials such as couplers and UV absorbing agents may be contained in a charged latex form, described in German Patent Laid-Open Publication 2,541,274 and Europatent Application 14,921.

Constituents may be also immobilized in the photographic sensitized materials as polymers. Please refer German Patent Laid-Open Publication 2,044,992, U.S. Pat. Nos. 3,370,952 and 4,080,211.

### EXAMPLES

The present invention will now be exemplified with examples.

### Example 1

A bleach-fixing concentrate was prepared according to the following prescription and sealed in a HDPE container at a void ratio of 20%. One container of the thus concentrate was stored for a given period at room temperature 25° C. and other was at a higher temperature of 40° C. After the stored concentrates were diluted to a given volume, the photographic sensitized materials were processed with an automatic processor. Then, edge staining on the reverse side of the processed photographic materials was determined. The processing conditions were based on the following table.

Each of the solutions to be evaluated was prepared based on the following, after filtration using a 30 μm mesh filter.

| | Processing | Processing |
|---|---|---|
| Processing Process: | temperature | time |
| 1) Color developing | 40° C. ± 0.3° C. | 22 seconds |
| process | | |
| 2) Bleach-fixing process | 38° C. ± 0.3° C. | 22 seconds |
| 3) Stabilizing process | 38° ± 0.3° C. | 22 sec. × 3 |
| (3 tank cascade) | | |
| Drying | 55° ± 0.3° C. | 30 seconds |

The photographic material to be processed:

The photographic material for evaluation was prepared under the following conditions.

Both sides of 110 μm thick pulp paper were laminated with high density polyethylene to obtain a paper support. In this regard, the emulsion coating side was laminated with melted polyethylene containing 15 weight % of dispersed surface treated anatase type titanium oxide, to prepare the reflecting support. A gelatin subbing layer was provided after a corona discharge treatment on the reflecting support. Further, the following photographic composition layers were coated onto the gelatin subbing layer to prepare Sample 1 of the silver halide photographic sensitized material.

Coating solutions were prepared in the following manner.

The first layer coating solution:

Ethyl acetate of 60 ml was added to dissolve yellow coupler (Y-1) of 3.34 g, yellow coupler (Y-2) of 10.02 g, yellow coupler (Y-3) of 1.67 g, dye image stabilizing agent (ST-1) of 1.67 g, dye image stabilizing agent (ST-2) of 1.67 g, dye image stabilizing agent (ST-5) of 3.34 g, anti-stain agent (HQ-1) of 0.167 g, image stabilizing agent (A) of 2.67 g, image stabilizing agent (B) of 1.34 g, high boiling point organic solvent (DBP) of 5.0 g, and high boiling point organic solvent (DNP) of 1.67 g. Then, the mixture was dispersed into a 7% gelatin aqueous solution of 320 ml containing 10% surface active agent (SU-1) of 5 ml using an ultrasonic homogenizer to obtain 500 ml yellow coupler dispersion liquid. This dispersion liquid was mixed with the blue sensitive silver chlorobromide emulsion (Em-B) prepared under the following conditions to obtain the first layer coating solution.

The second through the seventh layer coating solutions:

The second through the seventh layer coating solutions were each prepared in the same manner as the foregoing first layer coating solution, using the added amount shown in Tables 1 and 2.

Also, (H-1) and (H-2) were added as hardening agents. Surface active agents (SU-2) and (SU-3) were added as coating aids to adjust the surface tension. Further, F-1 was added to all layers at a total amount of 0.04 g/m².

TABLE 1

| | | Added |
|---|---|---|
| Layer | Composition | amount |
| The 7^{th} layer | Gelatin | 0.70 |
| (protective | DIDP | 0.002 |
| layer) | DBP | 0.002 |
| | Silicon dioxide | 0.003 |
| The 6^{th} layer | Gelatin | 0.40 |
| (ultraviolet | AI-1 | 0.01 |
| absorbing | Ultraviolet absorbing agent (UV-1) | 0.07 |
| layer) | Ultraviolet absorbing agent (UV-2) | 0.12 |
| | Anti-staining agent HQ-5) | 0.02 |
| The 5^{th} layer | Gelatin | 1.00 |
| (red | Red sensitive silver chlorobromide | 0.17 |
| sensitive | emulsion(Em-R) | |
| layer) | Cyan coupler (C-1) | 0.22 |
| | Cyan coupler (C-2) | 0.06 |
| | Dye image stabilizing agent (ST-1) | 0.06 |
| | Anti-staining agent (HQ-1) | 0.003 |
| | DBP | 0.10 |
| | DOP | 0.20 |
| The 4^{th} layer | Gelatin | 0.94 |
| (ultraviolet | AI-1 | 0.02 |
| absorbing | Ultraviolet absorbing agent (UV-1) | 0.17 |
| layer) | Ultraviolet absorbing agent (UV-2) | 0.27 |
| | Anti-staining agent (HQ-5) | 0.06 |

TABLE 2

| | | Added |
|---|---|---|
| Layer | Composition | amount |
| The 3^{rd} layer | Gelatin | 1.30 |
| (green | AI-2 | 0.01 |
| sensitive | Green sensitive silver | 0.12 |
| layer) | chlorobromide emulsion (Em-G) | |
| | Magenta coupler (M-1) | 0.05 |
| | Magenta coupler (M-2) | 0.15 |
| | Dye image stabilizing agent (ST-3) | 0.10 |
| | Dye image stabilizing agent (ST-4) | 0.02 |
| | DIOP | 0.10 |
| | DBP | 0.10 |
| The 2^{nd} layer | Gelatin | 1.20 |
| (inter | AI-3 | 0.01 |
| layer) | Anti-staining agent (HQ-1) | 0.02 |
| | Anti-staining agent (HQ-2) | 0.03 |
| | Anti-staining agent (HQ-3) | 0.06 |
| | Anti-staining agent (HQ-4) | 0.03 |
| | Anti-staining agent (HQ-5) | 0.03 |
| | DIOP | 0.04 |
| | DDE | 0.02 |
| The 1^{st} layer | Gelatin | 1.10 |
| (blue | Blue sensitive silver chlorobromide | 0.24 |
| sensitive | emulsion (Em-B) | |
| layer) | Yellow coupler (Y-1) | 0.10 |
| | Yellow coupler (Y-2) | 0.30 |
| | Yellow coupler (Y-3) | 0.05 |
| | Dye image stabilizing agent (ST-1) | 0.05 |
| | Dye image stabilizing agent (ST-2) | 0.05 |
| | Dye image stabilizing agent (ST-5) | 0.10 |
| | Anti-staining agent (HQ-1) | 0.005 |
| | Image stabilizing agent (A) | 0.08 |
| | Image stabilizing agent (B) | 0.04 |
| | DNP | 0.05 |
| | DDE | 0.15 |

| | |
|---|---|
| Support | Polyethylene laminated paper (containing a slight |
| | amount of a coloring agent) |

The added amounts of the silver halide emulsion are shown as converted to silver.

SU-1: sodium tri-i-propylnaphthalenesulfonate

SU-2: di (2-ethylhexyl) sufosuccinate-sodium

SU-3: di (2,2,3,3,4,4,5,5-octafluoropentyl) sulfosuccinate•sodium

DBP: dibutyl phthalate

DNP: dinonyl phthalate

DOP: dioctyl phthalate

DIDP: di-i-decyl phthalate

H-1: tetrakis (vinylsulfonylmethyl) methane

H-2: 2,4-dichloro-6-hydroxy-s-triazine-sodium

HQ-1: 2,5-di-t-octylhydroquinone

HQ-2: 2,5-di-sec-dodecylhydroquinone

HQ-3: 2,5-di-sec-tetradecylhydroquinone

HQ-4: 2-sec-dodecyl-5-sec-tetradecylhydroquinone

HQ-5: 2,5-di [(1,1-dimethyl-4-hexyloxycarbonyl) butyl] hydroquinone

Image stabilizing agent (A): p-t-octyl phenol

Image stabilizing agent (B): poly (t-butylacrylamide)

Chemical Formulas

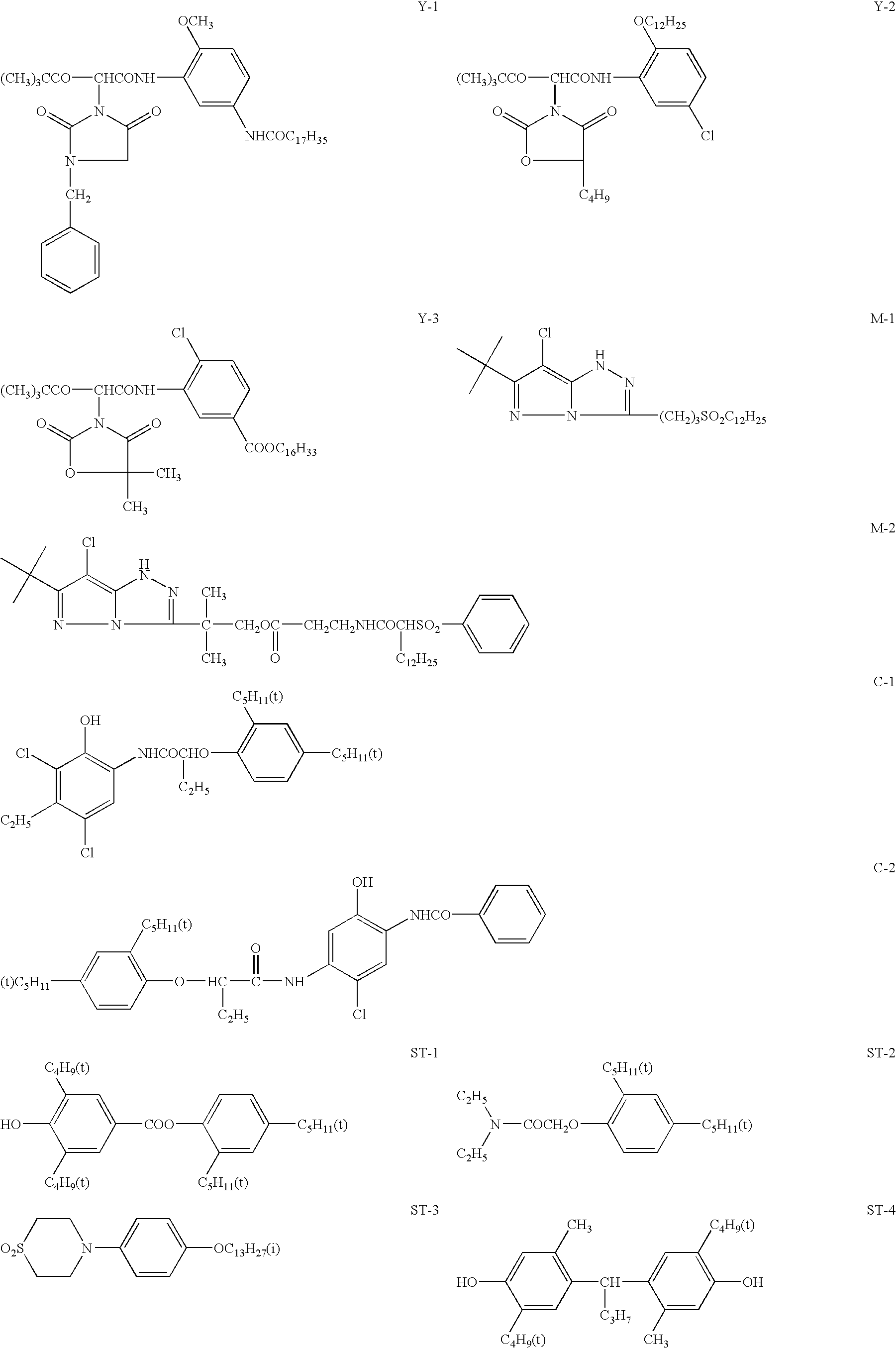

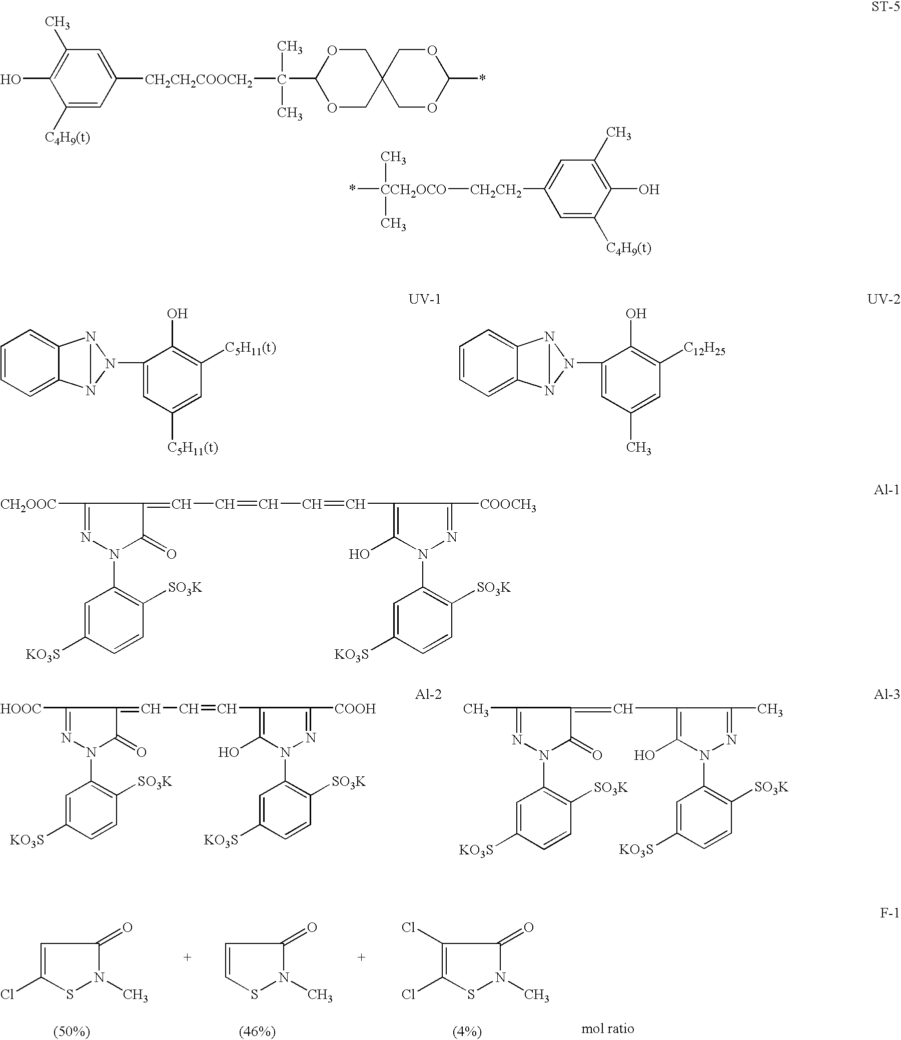

Preparation of Blue Sensitive Silver Halide Emulsion

Mono-dispersed cubic grain emulsion EMP-1 at an average grain size of 0.71 μm, a variation coefficient of grain distribution of 0.07, and a silver chloride content of 99.5% was prepared. Subsequently, mono-dispersed cubic grain emulsion EMP-1B at an average grain size of 0.64 μm, a variation coefficient of grain distribution of 0.07, and a silver chloride content of 99.5% was prepared.

The foregoing EMP-1 was subjected to optimal chemical sensitization using the following compounds. Also, EMP-1B was subjected to optimal chemical sensitization in the same way, after which the sensitized EMP-1 and EMP-1B were mixed at a silver content ratio of 1:1 to obtain blue sensitive silver halide emulsion (Em-B).

| | | |
|---|---|---|
| Sodium thiosulfate | 0.75 | mg/mol AgX |
| Chloroauric acid | 0.5 | mg/mol AgX |
| Stabilizing agent STAB-1 | 3 × 10⁻⁴ | mol/mol AgX |
| Stabilizing agent STAB-2 | 3 × 10⁻⁴ | mol/mol AgX |
| Stabilizing agent STAB-2 | 3 × 10⁻⁴ | mol/mol AgX |
| Sensitizing dye BS-1 | 4 × 10⁻⁴ | mol/mol AgX |
| Sensitizing dye BS-2 | 1 × 10⁻⁴ | mol/mol AgX |

Preparation of Green Sensitive Silver Halide Emulsion

Mono-dispersed cubic grain emulsion EMP-2 at an average grain size of 0.40 μm, a variation coefficient of grain distribution of 0.08, and a silver chloride content of 99.5% was prepared. Subsequently, mono-dispersed cubic grain emulsion EMP-2B at an average grain size of 0.50 μm, a variation coefficient of grain distribution of 0.08, and a silver chloride content of 99.5% was prepared.

The foregoing EMP-2 was subjected to optimal chemical sensitization using the following compounds. Further, EMP-2B was subjected to optimal chemical sensitization in the same way, after which sensitized EMP-2 and EMP-2B were mixed at a silver content ratio of 1:1 to obtain green sensitive silver halide emulsion (Em-G).

| | | |
|---|---|---|
| Sodium thiosulfate | 1.25 | mg/mol AgX |
| Chlorcauric acid | 1.0 | mg/mol AgX |
| Stabilizing agent STAB-1 | 3 × 10⁻⁴ | mol/mol AgX |
| Stabilizing agent STAB-2 | 3 × 10⁻⁴ | mol/mol AgX |
| Stabilizing agent STAB-2 | 3 × 10⁻⁴ | mol/mol AgX |
| Sensitizing dye GS-1 | 4 × 10⁻⁴ | mol/mol AgX |

Preparation of Red Sensitive Silver Halide Emulsion

Mono-dispersed cubic grain emulsion EMP-3 at an average grain size of 0.40 μm, a variation coefficient of grain distribution of 0.08, and a silver chloride content of 99.5% was prepared. Subsequently, mono-dispersed cubic grain emulsion EMP-3B at an average grain size of 0.38 μm, a variation coefficient of grain distribution of 0.08, and a silver chloride content of 99.5% was prepared.

The foregoing EMP-3 was subjected to optimal chemical sensitization using the following compounds. Further, EMP-3B was subjected to optimal chemical sensitization in the same way, after which sensitized EMP-3 and EMP-3B were mixed at a silver content ratio of 1:1 to obtain red sensitive silver halide emulsion (Em-R).

| | | |
|---|---|---|
| Sodium thiosulfate | 1.6 | mg/mol AgX |
| Chlorcauric acid | 2.0 | mg/mol AgX |
| Stabilizing agent STAB-1 | 3 × 10⁻⁴ | mol/mol AgX |
| Stabilizing agent STAB-2 | 3 × 10⁻⁴ | mol/mol AgX |
| Stabilizing agent STAB-2 | 3 × 10⁻⁴ | mol/mol AgX |
| Sensitizing dye RS-1 | 1 × 10⁻⁴ | mol/mol AgX |
| Sensitizing dye RS-2 | 1 × 10⁻⁴ | mol/mol AgX |

STAB-1: 1-(3-acetoamidephenyl)-5-mercaptotetrazole

STAB-2: 1-phenyl-5-mercaptotetrazole

STAB-3: 1-(4-thoxyphenyl)-5-mercatotetrazole

SS-1 of 2.0×10-3 mol/mol AgX was also added to the red sensitive emulsion.

Chemical Formulas:

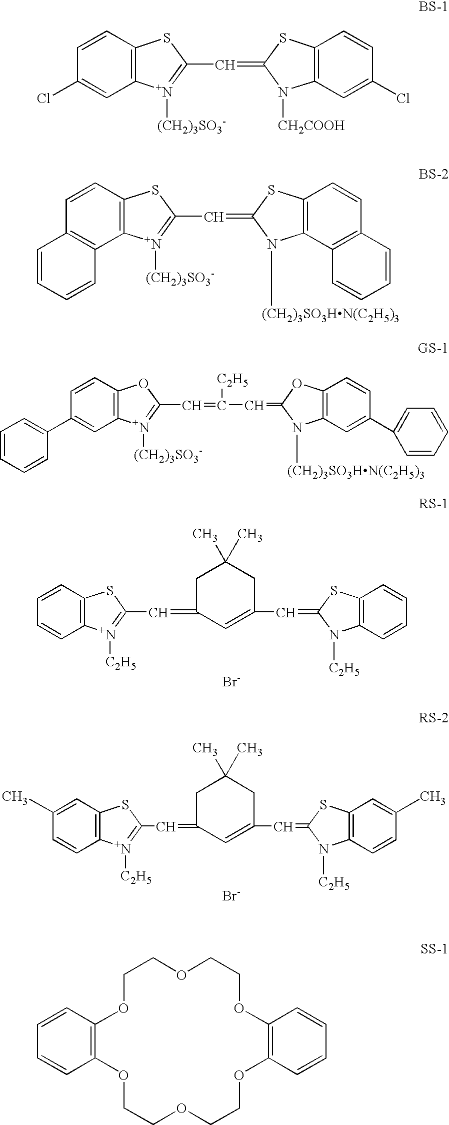

Color Developing Solution, Color Developing Solution Replenishing Solution:

A new solution (being the tank solution) and the replenishing solution were prepared using the chemicals for the CPK-2-28 Process, Color Developing Replenishing Solution Kit 28P-1, and Color Developing Replenishing Solution Starter 28P-1S, produced by Konica Corp.

Bleach-fixing solution:

| | | |
|---|---|---|
| Water | | |
| Sulfites | total amount | 0.2 mol |
| (sodium or ammonium salts) | | |
| Thiosulfates | total amount | 1.55 mol |
| (sodium or ammonium salt) | | |
| Compound 1 | total amount | 0.4 mol |
| (described in Table 1) | | |
| (sodium or ammonium salt) | | |
| Aminopolycarboxylic acid | | 0.004 mol |
| Succinic acid | | 0.03 mol |
| Maleic acid | | 0.04 mol |

Water was added to make 1 liter, and the pH was adjusted to 6.1 using sodium hydroxide, aqueous ammonia or sulfuric acid may also be used.

The ammonium ion ratio was also adjusted by composition of sulfites, thiosulfates and compounds having different cations.

Stabilizing Solution (Tank Solution, Replenishing Solution):

A new solution (being tank solution) and the replenishing solution were prepared using the chemicals for the CPK-2-28 Process, and Stabilizing Solution Replenishing Solution Kit 28P-3, produced by Konica Corp.

Evaluation was conducted by measurement of the staining depth from the edge and visual evaluation, whereby (A: practically no problems, B: staining was slight, C: staining was obvious).

The bleach-fixing solutions prepared and stored in the foregoing manner were diluted by a factor of 4, and in addition, the color developing solution was added for 20% for the actual processing. The evaluation results of the edge staining on the photographic materials under the foregoing conditions are shown Table 3.

TABLE 3

| Compound of | | | | | | | | | | | |
|---|---|---|---|---|---|---|---|---|---|---|---|
| Formulas | | | | | | | | | | | |
| (1), (1B), (1C) | | | | | | | | | | | |
| (APC-Fe) | | NH₄ | Edge staining | | | | Edge staining | | | | |
| | Concen- | Concen- | Storage (25° C.) | | | | Storage (40 ° C.) | | | | |
| | tration | tration | 1 mo. | 3 mos. | 6 mos. | 12 mos. | 3 mos. | 6 mos. | 12 mos. | | |
| Compound | (mol) | (mol %) | (mm) | (mm) | (mm) | (mm) | (mm) | (mm) | (mm) | Result | |
| EDTA | 0.4 | 100 | 1.2 | 1.5 | 1.8 | 2.5 | 1.9 | 2.5 | 3.6 | C | Comp. |
| EDTA | 0.4 | 80 | 1.1 | 1.5 | 1.8 | 2.2 | 1.9 | 2.2 | 3.5 | C | Comp. |
| EDTA | 0.4 | 60 | 1.1 | 1.4 | 1.7 | 2.0 | 1.8 | 2.2 | 3.3 | B-C | Comp. |
| EDTA | 0.4 | 50 | 1.1 | 1.3 | 1.4 | 1.6 | 1.5 | 1.8 | 2.6 | B | Inv. |
| EDTA | 0.4 | 40 | 1.1 | 1.2 | 1.4 | 1.5 | 1.5 | 1.7 | 2.5 | B | Inv. |
| EDTA | 0.4 | 30 | 1.1 | 1.2 | 1.4 | 1.5 | 1.5 | 1.7 | 2.4 | A-B | Inv. |
| EDTA | 0.4 | 20 | 1.0 | 1.2 | 1.2 | 1.3 | 1.4 | 1.6 | 1.8 | A | Inv. |
| EDTA | 0.4 | 0 | 1.0 | 1.2 | 1.3 | 1.3 | 1.3 | 1.4 | 1.6 | A | Inv. |
| DTPA | 0.4 | 100 | 1.6 | 2.3 | 2.6 | 3.2 | 2.3 | 3.0 | 4.2 | C | Comp. |
| DTPA | 0.4 | 80 | 1.5 | 2.2 | 2.5 | 3.2 | 2.1 | 2.9 | 3.9 | C | Comp. |
| DTPA | 0.4 | 60 | 1.5 | 2.2 | 2.3 | 2.9 | 2.1 | 2.9 | 3.8 | C | Comp. |
| DTPA | 0.4 | 50 | 1.5 | 1.8 | 2.0 | 2.2 | 1.6 | 2.2 | 2.9 | B | Inv. |
| DTPA | 0.4 | 40 | 1.4 | 1.6 | 1.7 | 1.9 | 1.5 | 2.0 | 2.5 | B | Inv. |
| DTPA | 0.4 | 30 | 1.4 | 1.6 | 1.7 | 1.8 | 1.5 | 1.8 | 2.5 | A-B | Inv. |
| DTPA | 0.4 | 20 | 1.4 | 1.5 | 1.6 | 1.8 | 1.5 | 1.6 | 2.1 | A | Inv. |
| DTPA | 0.4 | 0 | 1.4 | 1.4 | 1.6 | 1.6 | 1.4 | 1.5 | 1.6 | A | Inv. |
| (1)-1 | 0.4 | 100 | 1.0 | 1.2 | 1.6 | 2.0 | 1.7 | 2.1 | 3.0 | C | Comp. |
| (1)-1 | 0.4 | 80 | 1.0 | 1.1 | 1.4 | 2.0 | 1.6 | 2.1 | 2.8 | C | Comp. |
| (1)-1 | 0.4 | 60 | 0.9 | 1.1 | 1.3 | 1.9 | 1.6 | 2.0 | 2.7 | B-C | Comp. |
| (1)-1 | 0.4 | 50 | 0.6 | 0.7 | 0.9 | 1.3 | 0.9 | 1.5 | 2.1 | A-B | Inv. |
| (1)-1 | 0.4 | 40 | 0.6 | 0.5 | 0.8 | 1.1 | 0.7 | 1.3 | 1.9 | A | Inv. |
| (1)-1 | 0.4 | 30 | 0.5 | 0.6 | 0.7 | 0.9 | 0.6 | 1.3 | 1.5 | A | Inv. |
| (1)-1 | 0.4 | 20 | 0.3 | 0.3 | 0.4 | 0.6 | 0.5 | 0.8 | 1.1 | A | Inv. |
| (1)-1 | 0.4 | 0 | 0.2 | 0.3 | 0.3 | 0.5 | 0.2 | 0.5 | 0.9 | A | Inv. |
| 1B-1 | 0.4 | 40 | 0.6 | 0.6 | 0.7 | 1.1 | 0.7 | 1.3 | 2.0 | A | Inv. |
| 1B-3 | 0.4 | 40 | 0.6 | 0.7 | 0.8 | 1.2 | 0.8 | 1.4 | 2.1 | A | Inv. |
| 1C-1 | 0.4 | 40 | 0.6 | 0.8 | 0.9 | 1.3 | 0.7 | 1.3 | 2.0 | A | Inv. |
| 1C-20 | 0.4 | 40 | 0.5 | 0.6 | 0.7 | 1.1 | 0.6 | 1.2 | 1.9 | A | Inv. |

Comp.; Comparative sample
Inv.; Inventive sample
EDTA: sodium ethylenediaminetetraacetate iron (III) or ammonium ethylenediaminetetraacetate iron (III)
DTPA: sodium diethylenetetraminepentaacetate iron (III) or ammonium diethylenetetraminepentaacetate iron (III)
EDDS: sodium ethylenediaminedisuccinate iron (III) or ammonium ethylenediaminedisuccinate iron (III)

Staining on the photographic material edges tended to deteriorate due to storage in a concentrated form, not depending on the types of iron salts, and then, the degree of deterioration was slight along with a decrease of ammonium ion containing ratio. Thus, it was proved that there was a significant positive effect to reduce staining on the edges by adjusting the ammonium ion containing ratio to 50% or less, even when any of aminopolycarboxylic acid iron salts was used. Further, it was proved that 20% or even less of that was specifically preferable. Of the types of iron salts, it was also proved that EDDS was advantageous to reduce staining on the edges.

### Example 2

The bleach-fixing concentrate was prepared in the same manner as Example 1, and sealed in a HDPE (high density polyethylene) container at a void ratio of 20%. One container of the thus concentrate was stored for a given period at room temperature of 25° C. and other was at a high temperature of 40° C. After the stored concentrates were diluted to a given volume, the photographic sensitized materials were processed with an automatic processor. Then, edge staining on the reverse side of the processed photographic materials was evaluated. The processing conditions are listed in the following table.

Each of the solutions to be evaluated was prepared based on the following, after filtration with a 30 μm mesh filter.

| | Processing | Processing |
|---|---|---|
| Processing Process: | temperature | time |
| 1) Color developing | 40° C. ± 0.3° C. | 22 seconds |
| process | | |
| 2) Bleach-fixing process | 38° C. ± 0.3° C. | 22 seconds |
| 3) Stabilizing process | 38° ± 0.3° C. | 22 sec. × 3 |
| (3 tank cascade) | | |
| Drying | 55° ± 0.3° C. | 30 seconds |

The photographic material to be processed:

The same photographic material for evaluation was used as Sample 1 prepared in the foregoing conditions.

Color Developing Solution, Color Developing Solution Replenishing Solution:

A new solution (being the tank solution) and the replenishing solution were prepared using the processing chemicals for the CPK-2-28 Process, Color Developing Replenishing Solution Kit 28P-1, and Color Developing Replenishing Solution Starter 28P-1S, all produced by Konica Corp.

Bleach-fixing solution:

| | | |
|---|---|---|
| Water | | to make |
| | | 1-liter |
| Sulfites (sodium or ammonium salts) | total amount | 0.2 mol |
| Thiosulfates (sodium or ammonium salt) | total amount | 1.55 mol |
| Compound of Formula (2) | total amount | 0.4 mol |
| (described in Table 2) | | |
| (sodium or ammoniurn salt) | | |
| Aminopolycarboxylic acid | | 0.004 mol |
| Succinic acid | | 0.03 mol |
| Maleic acid | | 0.04 mol |

Water was added to make 1 liter, and the pH was adjusted to 6.1 using sodium hydroxide, aqueous ammonia or sulfuric acid.

The ammonium ion ratio was also adjusted by the composition of sulfites, thiosulfates and compounds having different cations.

Stabilizing Solution, (Tank Solution, Replenishing Solution):

A new solution (being tank solution) and the replenishing solution were prepared by using processing chemicals for the CPK-2-28 Process, and Stabilizing Solution Replenishing Solution Kit 28P-3, both produced by Konica Corp.

The bleach-fixing solutions prepared and stored in the foregoing manner were diluted by a factor of 4, and in addition, the color developing solution was added for 20% for the actual processing. The evaluation results of edge staining on the photographic materials under the foregoing conditions are shown in Table 4.

TABLE 4

| Compound of Formulas | | | | | | | | |
|---|---|---|---|---|---|---|---|---|
| (1), (1B), (1C) | | NH₄ | | Edge staining | | | | |
| (APC-Fe) | | Concen- | Compounds | Storage (25 ° C.) | | | | |
| | Concentration | tration | of Formulas | 1 mo. | 3 mos. | 6 mos. | 12 mos. | |
| Compound | (mol) | (mol%) | [I]-[IV] | (mm) | (mm) | (mm) | (mm) | |
| DTPA | 0.4 | 50 | None | 1.5 | 1.8 | 2.0 | 2.2 | Inv. |
| DTPA | 0.4 | 50 | I-I | 1.4 | 1.7 | 1.8 | 2.0 | Inv. |
| DTPA | 0.4 | 50 | II-2 | 1.4 | 1.6 | 1.9 | 2.1 | Inv. |
| DTPA | 0.4 | 50 | II-14 | 1.3 | 1.6 | 1.7 | 1.9 | Inv. |
| DTPA | 0.4 | 50 | III-9 | 1.3 | 1.5 | 1.7 | 1.9 | Inv. |
| DTPA | 0.4 | 50 | III-10 | 1.1 | 1.4 | 1.6 | 1.8 | Inv. |
| DTPA | 0.4 | 50 | III-13 | 1.3 | 1.5 | 1.6 | 1.7 | Inv. |
| DTPA | 0.4 | 50 | III-23 | 1.2 | 1.5 | 1.6 | 1.8 | Inv. |
| DTPA | 0.4 | 50 | IV-3 | 1.3 | 1.4 | 1.7 | 1.9 | Inv. |
| DTPA | 0.4 | 50 | Iv-5 | 1.5 | 1.6 | 1.9 | 2.1 | Inv. |
| DTPA | 0.4 | 50 | IV-1 | 1.2 | 1.5 | 1.6 | 1.8 | Inv. |
| DTPA | 0.4 | 50 | v-2 | 1.3 | 1.6 | 1.7 | 2.0 | Inv. |

Inv.; Inventive sample

As is apparent from Table 4, it was proved that addition of the compounds represented by Formulas [I] through [V] enhanced the effects of the present invention, resulting in exhibiting the preferable effect to prevent staining on photographic material edges. Further, the compounds represented by Formulas [I] through [V] exhibited an acceleration function of bleaching and fixing, resulting in completion of the bleach-fixing process with a lower amount of iron salts. Accordingly, these compounds exhibited the feature of further reducing edge staining.

### Example 3

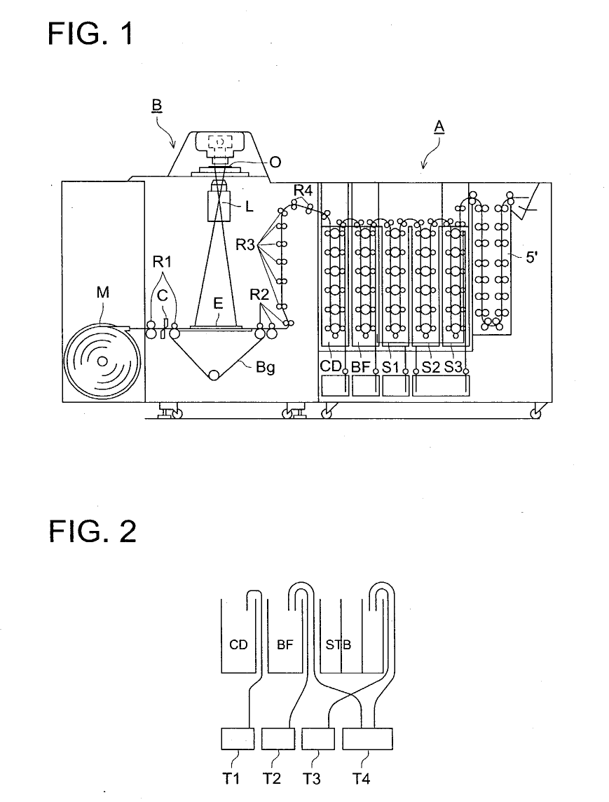

Processing was conducted using the processing apparatus (the usual automatic processor, having a replenishing solution tank holding a processing solution in concentrated form, a pump supplying the concentrate to the processing tank, and a pump supplying dilution water to the processing tank) shown in FIG. 1 and FIG. 2.

In FIG. 1, Magazine M containing rolls of photographic paper of unexposed photographic materials is provided in the lower left portion of Photo printer B. The photographic paper pulled from the magazine is cut into paper sheets, transferred through Transfer Rollers R1 and Cutter C. These paper sheets are transferred by Belt Transfer Device Be and exposed images of Original Image O at Exposure Section E by a light source sent through a lens. The exposed paper was transferred through plural paired Feed Rollers R2, R3, and R4, and brought into Automatic processor A. In automatic processor A, the paper sheets transferred sequentially through the processing tanks of Color Developing Tank CD, Bleach-Fixing Tank BF and Stabilizing Tanks S1 (SR-1), S2 (SR-2) and S3 (SR-3) (Processing Bath 1 of a basically 3-tank configuration) by a roller transfer means (no ref. number), and conducted each of color developing process, bleach-fixing process and stabilizing process. The sheet paper processed with each process was ejected from the apparatus, after drying in Drying Section 5′.

In FIG. 2, T1 designates a replenishing tank for a color developer, T2 designates a replenishing tank for a bleach-fixing solution, T3 designates a replenishing tank for a stabilizing solution and T4 designates a replenishing tank for water.

| | Processing | Processing | Replenishing |
|---|---|---|---|
| Processing processes: | temperature | time | rate |
| 1) Color developing | 40° C. ± 0.3° C. | 22 seconds | 110 ml/m² |
| process | | | |
| 2) Bleach-fixing | 38° C. ± 0.3° C. | 22 seconds | 40 + 100 |
| process | | | ml/m² |
| 3) Stabilizing process | 38° ± 0.3° C. | 22 sec. × 3 | 20 + 130 |
| (3 tank cascade) | | | ml/m² |
| 4) Dry | 55° ± 0.3° C. | 30 seconds | — |

The replenishment of the color developing process is to replenish the color developing replenishing solution at 110 ml/m² to the color developing process tank. The replenishment of the bleach-fixing process is to replenish each of the bleach-fixing replenishing solutions at 40 ml/m² and water at 100 ml/m² to the bleach-fixing process tank. The replenishment of the stabilizing process is to replenish each of the stabilizing replenishing solutions at 20 ml/m² and water at 130 ml/m² to the stabilizing process tank.

Processing Solution:

Color Developing Solution, Color Developing Replenishing Solution

The new solution (the tank solution) and the replenishing solution were prepared using the processing chemicals for CPK-2-28 Process, Color Developing Replenishing Solution Kit 28P-1, and Color Developing Replenishing Solution Starter 28P-1S, all produced by Konica Corp.

Bleach-fixing solution

| | |
|---|---|
| Water | to make 1 liter |
| Sodium sulfites | 0.2 mol |
| Sodium thiosulfates | 1.55 mol |
| Sodium | 0.4 mol |
| ethylenediaminedisuccinate | |
| iron (III) | |
| Succinic acid | 0.03 mol |
| Maleic acid | 0.04 mol |
| Compound (III-1) | 0.01 mol |

Water was added to make 1 liter, and the pH was adjusted to 6.1 by using aqueous ammonium or sulfuric acid.

Stabilizing Solution (Being a Tank Solution and a Replenishing Solution)

A new solution (being tank solution) and the replenishing solution were prepared using processing chemicals for the CPK-2-28 Process, and Stabilizing Solution Replenishing Solution Kit 28P-3, both produced by Konica Corp.

Based on Example 3, it was proved that to complete the down sizing of the replenishing tanks and the automatic processor itself, one solution is providing the mechanism of replenishing the replenishing solution and water separately in the bleach-fixing process and the stabilizing process. At the same time, reduction of working time for preparation of the bleach-fixing replenishing solution and the stabilizing replenishing solution was realized. Further, the noxious odor problem was considerably solved in the processing operation.

According to the present invention, it is possible to provide an effective one-part bleach-fixing solution for photographic sensitized materials, which addresses the unpleasant odor matter, is a concentrated one part kit form and sufficiently restrains edge penetration during processing after storage in commercial product form, and a processing method thereof.

What is claimed is:

1. A one-part photographic bleach-fixing concentrate comprising cationic ions,
wherein the concentrate comprises an iron (III) complex salt of an aminopolycaroxylic acid in an amount of 0.3 to 0.6 mol/l and ammonium ions in an amount of 0 to 50 mol % based on the total cationic ions.

2. The one-part photographic bleach-fixing concentrate of claim 1, wherein the aminopolycaroxylic acid is represented by Formulas (1) (1B) or (1C): 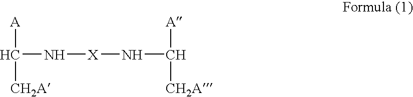
wherein each A, A′, A″ and A′″ is independently —CH₂OH, —PO₃(M)₂ or —COOH; M is a hydrogen atom, an ammonium group, an organic ammonium group or an alkaline metal atom; X is an alkylene group with 2 to 6 carbon atoms or —(YO)ₙ—Y′—; n is an integer of 1 to 6; and each Y and Y′ is independently an alkylene group with 1 to 5 carbon atoms, 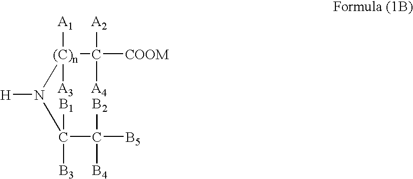
wherein n′ is an integer of 1 to 3; A₁, A₂, A₃, A₄, B₁, B₂, B₃, B₄ and B₅ are each independently a hydrogen atom, an —OH group, a —CₙH₂ₙ₊₁ group, or a —(CH₂)ₗX group in which n is an integer 1 to 3; l is an integer of 0 to 3; X is a —COOM group, an —NH₂ group or an —OH group, in which M is a hydrogen atom, an alkali metal ion or another cation; provided that all of B₁, B₂, B₃, B₄ and B₅ are not hydrogen atoms at the same time; 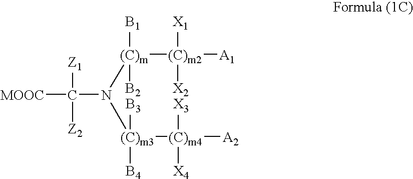
wherein B₁, B₂, B₃, B₄, X₁, X₂, X₃ and X₄ are each independently a hydrogen atom, a —CₙH₂ₙ₊₁ group or a —(CH₂)ₗY; n and l are each an integer of 1 to 3 and 0 to 3, respectively; Y is a —COOM group, an —NH₂ group or a —OH group in which M is a hydrogen ion, an alkali metal ion or another cation, provided that all of B₁, B₂, B₃ and B₄ are not hydrogen atoms at the same time, and all of X₁, X₂, X₃ and X₄ are not hydrogen atoms at the same time and any number, except 2, of X₁, X₂, X₃ and X₄ may be —OH groups at the same time; m₁, m₂, m₃ and m₄ are independently an integer of 0 to 3; and A₁ and A₂ are each a —COOM₁ group, a —COOM₂ group, an —NH₂ group or an —OH group in which M₁ and M₂ are each a hydrogen ion, a alkali metal ion or another cation; and Z₁ and Z₂ are each a —COOM₁ group, —COOM₂ group a alkali metal. ion or another cation, an alkyl group having 1 to 3 carbon atoms or an —OH group in which M₁ and M₂ are each a hydrogen ion, a alkali metal ion or another cation.

3. The one-part photographic bleach-fixing concentrate of claim 1, wherein a compound represented by Formula (2) is further contained:
A—(COOM)ₙ Formula (2)
wherein n is an integer of 2 or 3; A is a single bond or a divalent organic group when n is 2, A is a trivalent organic group when n is 3; and M is a hydrogen atom, an alkaline metal atom or an ammonium group, provided that a plurality of M may be the same or different form each other.

4. The one-part photographic bleach-fixing concentrate of claim 1, wherein a compound represented by Formula (I), Formula (II), Formula (III), Formula (IV)) or Formula (V) is further contained: 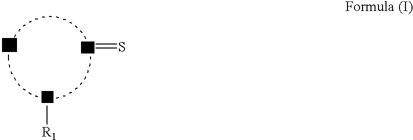
wherein Q is a group of atoms necessary to form a heterocylic ring; and R₁ is a hydrogen atom, an alkyl group with 1 to 6 carbon atoms, a cycloalkyl group, an aryl group, a heterocyclic group or an amino group, 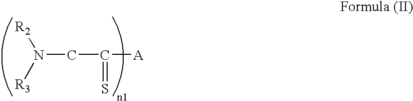
wherein each R₂ and R₃ is independently an alkyl group with 1 to 6 carbon atoms, a hydroxy group, an amino group, an acyl group with 1 to 3 carbon atoms, an aryl group or an alkenyl group;
A is selected from the group consisting of: —(C═X)—N(R), —(CH₂)n₂—(C═X)—N(R)(R′), —(S)m₁—(C═X)—N(R)(R′), —(S)m₂-(CH₂)n₃—(C═X)(R)(R′), —(S)m₃-(CH₂)n₄-N(R)(R′), —(S)m₄—N(R)(R′), —(NH)n₅—(CH₂)m₅—(NH)n₆—(C═X)—N(R)(R′), —S—S—(C═X)—N(R)(R′), —SZ, and n₁-valent heterocyclic residue;
R and R′ are each the same as R₂ and R₃,
X represents ═S, ═O, or ═NR″,
Z represents a hydrogen atom, an alkali metal atom, an ammonium group, an amino group, a heterocyclic residue containing a nitrogen atom, an alkyl group, or —S—B—Y(R₄) (R₅);
R″ represents a hydrogen atom, an alkyl group having 1 to 6 carbon atoms, a cycloalkyl group, an aryl group, a heterocyclic residue or an amino group;
n₁ to n₆ and m₁ to m₅ each represents an integer of 1 to 6;
B represents an alkylene group having 1 to 6 carbon atoms;
Y represents —N<, =C<, or CH<;
R₄ and R₅ are the same as R₂ and R3, provided that R₄ and R₅ may each represent —B—SZ; and
R₂ and R₃, R and R′, R₄ and R₅ may each form a ring bonded to each other, 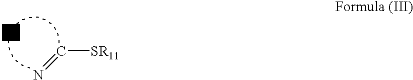
wherein Q₁ represents a group of atoms which is necessary to form a heterocycle containing a nitrogen atom;
R₁₁′ represents a hydrogen atom, an alkali metal atom, 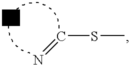
or an alkyl group; and
Q′ is identical to Q₁, 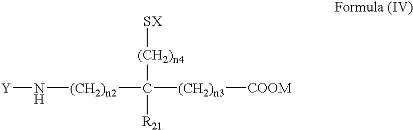
wherein n₂, n₃ and n₄ each represent an integer of 0 to 5;
X represents a hydrogen atom, or an alkyl group having 1 to 5 carbon atoms;
Y represents a hydrogen atom, a substituted or unsubstituted alkyl group, an acyl group;
M represents a hydrogen atom, or an alkali metal atom; and
R₂₁ represents a substituted or unsubstituted alkyl group having 1 to 5 carbon atoms, or a hydrogen atom,
a disulfide dimer of Formula (IV) being included,
Z₁—(CH₂)ₙ₅—S[(CH₂)ₙ₆—S]ₙ₇—(CH₂)ₙ₈—S—(CH₂)ₙ₉—Z₂ Formula (V)
wherein Z₁ and Z₂ represent a hydrogen atom, an alkyl group having 1 to 3 carbon atoms, an amino group, a carboxyl group, a sulfo group, or a hydroxyl group; and
n₅, n₆, n₇, n₈ and n⁹ represent an integer of 0 to 5.

5. The one-part photographic bleach-fixing concentrate of claim 1, wherein a ratio of ammonium ions to the total cationic ions is 0 to 20 mol %.

6. A method for processing a silver halide photographic material comprising a step of:
introducing the one-part photographic bleach-fixing concentrate of claim 1 into a bleach-fixing bath of an automatic processor.

7. The method for processing a silver halide photographic material of claim 6, wherein water is introduced in the bleach-fixing bath of an automatic processor.
